(19) United States
(12) Patent Application Publication
(10) Pub. No.: US 2019/0392401 A1
(43) Pub. Date: Dec. 26, 2019

(54) Mobile vehicle diagnosis, and repair referral, system and services

(71) Applicant: Enrique BELLINI, Escondido, CA (US)

(72) Inventor: Enrique BELLINI, Escondido, CA (US)

(21) Appl. No.: 15/732,386

(22) Filed: Nov. 3, 2017

(51) Int. Cl. G06Q 10/00; G07C 5/00

(52) U.S. Cl. CPC G06Q 10/20; G07C 5/006; G07C 5/008

(57) ABSTRACT

A vehicular problem diagnosis agency enrolling a number of vehicular repair shops receives communications from owner/operators of vehicles needing repair to do any and all of (1) diagnose the problem(s) with their vehicles, (2) provide a cost estimation as to what the vehicle repair(s) will cost, and (3) make a referral to an enrolled repair shop capable to perform the necessary repair(s). A mobile problem diagnosis service representative (“MDSR”) travels to the vehicle and provides the vehicle owner/operator with services (1) through (3), normally at a modest fixed fee. If the vehicle owner/operator actually has the vehicle repaired at an enrolled and referred repair shop then the repair shop pays a referral fee, most normally as a percentage of all services actually performed for the vehicle owner/operator, to the agency.

### BACKGROUND OF THE INVENTION

### 1. Field of the Invention

The present invention generally concerns (1) a system and (2) a business method for providing vehicular problem diagnosis and/or repair services.

The present invention more particularly concerns a system, and a business method, wherein (1) an independent organization—called an “agency” because it ultimately serves as an agent of a vehicle owner/operator—(2) effects mobile on-site diagnosis of a vehicle exhibiting one or more failures in order to (2a) identify said failure(s) and needed repair(s) to the owner/operator of the vehicle, and (2b) refer this vehicle owner/operator to (3) a particular one or ones of many vehicular repair services organizations (“repair shops”) that is (are) most appropriate to perform needed repairs. Sometimes, and occasionally, the (1) agency will itself (2c) perfunctorily effect needed vehicle repair(s). Sometimes, and occasionally, the (1) agency will serve as a concierge to (2d) transport the vehicle to one of the (3) repair services organizations.

Still further, the present invention concerns a system, and a business method, where (3) vehicular repair service organizations pay referral fees to (1) a central agency in return for the agency's (2b) referral of the vehicles for repairs that are subsequently actually accomplished.

### 2. Background of the Invention

Circa 2017 several services located in several geographical areas of the United States permit the owner/operator of a vehicle to book mobile vehicle repair service(s) online so that a mechanic will come to that person's home or office to service a subject car or, more rarely, a truck. These systems include Yourmechanic, currently (circa 2017) available in 700 U.S. cities.

Yourmechanic advertises on their website circa 2017 to “[book a service online and our mechanic will come to your home or office to service your car. We make the entire process easy for you. Using our website and mobile applications, you can access the maintenance schedule of all your cars, get a fair and transparent price, book an appointment, make payments, access service history and get maintenance reminders. And since we don't have the overhead cost of a shop, we are able to charge less while providing a convenient service.”

Yourmechanic continues: “Scheduling Your Appointment is Easy. HERE IS WHAT WE NEED[:] 1. What you think is wrong (e.g., “my car is shaking” or “I need new brakes”)[,] 2. The year, make, and model of your car [, and] 3. Your name, email address, phone number, and zip code.”

Your mechanic continues “GET A FAIR AND TRANSPARENT PRICE . . . . We'll provide a detailed list of the parts, services, and costs needed to service your car. In most cases, we will provide a fair and transparent price instantly. All our mechanics have agreed to honor the quotes we provide. This ensures that there will be no need for negotiations or any last minute surprises.”

Your mechanic continues “SCHEDULE YOUR APPOINTMENT . . . . Before you schedule your appointment, we provide your mechanic's certifications, work history, ratings and reviews from other customers. Our mechanics are available 7 days a week from 7 am to 9 pm. Simply select a time that works for you and provide payment information to book your service. A credit card is required to book your appointment but we won't bill your card until the work is done, and of course you can always manage your booking 24/7 from our website or mobile app.”

The entire process is alleged to be easy for the user—as the system and method of the present invention will likewise turn out to be.

These previous systems use web sites and mobile applications. They sometimes offer that a system user can access the maintenance schedule of all his, her or their cars. They claim to offer a fair and transparent price, book appointments, accept payments, access service history and offer maintenance reminders. The major selling point seems to be that since the on-call mobile repair services don't have the overhead cost of a shop, they are able to charge less while providing a convenient service.

Importantly to the distinction of Yourmechanic from the vehicular repair system of the present invention, Yourmechanic states in response to inquiry as to whether their mechanic can really fix a customer's car at the customer's location that: “All maintenance and basic repairs can be done right in your driveway. Our certified mobile mechanics carry all the tools, scanners and lifts to do most repairs at your home or office. We service several thousand cars every month, from simple jobs such as oil changes and replacing brakes to more complex repairs like replacing timing belts. As long as you have a driveway, parking lot or garage, you can use this extremely convenient service.

“[Over 500 services [are provided], including brakes, belts, hoses, fluids, lights, sensors, check engine lights, no-start inspections, leaks, and much more.”

In direct response to the question as to whether Yourmechanic has a shop where a customer can bring his/her/its car, Yourmechanic answers: “Our mechanics come to you and provide services at the convenience of your home or office. We do not have a shop location where you can bring your car.”

There are severe problems with this business model. Foremost is that very many, even most, automotive repairs are not suitably done in the out-of-doors in all climates and seasons. Even the types of repairs performed “in the customer's driveway” by Yourmechanic are manifestly better performed under indoor garage conditions. For example, access to the underside of a car's engine for a simple oil change is much easier and faster and more precise when the car is on a lift, and spillage of oil on the owner/operator's driveway is avoided when the car is serviced in a proper garage.

Automobiles needing repair(s) are not always located in safe and suitable locations so as to permit the repair(s). For example, an auto may be parked on an incline of any direction, and/or on a busy street, interfering with any safe change of, for example, oil, or tire(s).

Despite being informed in advance of the car type, model and year, it is effectively impossible for a mobile auto repair vehicle to carry all the parts that may be unexpectedly diagnosed to be needed for even the simplest repairs, and the parts inventory of a repair van that must also carry diagnostic equipment and tools will always be inferior to that of even a modest repair garage.

Still other, more subtle, problems exist. Because of its location that is most typically in the out of doors, and subject to inclement weather, the problems with a car may not be fully diagnosed nor successfully repaired by a mobile mechanic such as is furnished by Yourmechanic. Both diagnosis and repair often require the specialty equipments, and support environment dedicated to repair of an repair shop, Indeed, even repair shops are specialized, with those performing engine versus transmission versus running gear versus bodywork all having differences.

I a worse case attempted vehicle diagnosis and/or repair in the out-of-doors may result in the vehicle being turned back to the owner/operator in (1) unsafe condition, (2) with undiagnosed and uncompleted but necessary repairs likely to cause further, secondary, failures, and/or (3) without even the full repairs presently called for being properly diagnosed and/or performed. Even more insidious, a mobile mechanic may note, or may suspect, certain car problem and/or failure conditions but, unable to then and there perform repairs for profit, intentionally fail to mention these discovered problems and conditions to the owner/operator because it can only result in dissatisfaction that not all detected of suspected problems have been resolved.

Problems with the car bodywork and chassis are, by and large, unaddressed, and, as a practical matter, not susceptible of being addressed, by a mobile mechanic such as from Yourmechanic. In summary, Yourmechanic promotes that the owner/operator of a car needing repair may save time and aggravation by having repairs performed by a mobile mechanic. For this the owner/operator pays a price that is not in money. The owner/operator may not properly recognize the problems that beset his/her car, impairing their rectification. The owner/operator is, by definition, neither having his/her car repaired (1) by a person, out of many, imminently best identified to be able to do the repair successfully, quickly and economically, nor (2) in the best physical circumstances to effect the repair—as would be the case in a repair garage(s) of the proper type(s).

Doing auto problem diagnosis and repair “in the wild” is—in the opinion of the inventor who heads, circa 2017, an enterprise some 40 years in the business of auto repair—a very poor idea. The entire thrust of civilization is towards specialization, and to, insofar as proves possible, to bring machines that have failed to locations that specialize in their correct, speedy and effective repair.

### SUMMARY OF THE INVENTION

1. Purposes of the Present Invention

The present invention is directed to alleviating the continuing, and likely presently increasing, consumer frustration with the automotive repair industry. Namely, and despite modern electronic aids to auto problem diagnosis, a consumer needing auto repair services often (1) cannot understand precisely what is wrong with his/her increasingly sophisticated vehicle, (2) does not know how to identify, and communicate his/her auto repair requirements, to an appropriate auto repair organization. The consumer (3) does not understand the options available to him/her for auto repair, nor know whether he or she is being fairly charged for only such repairs as are needed. Finally, the consumer (4) may think that he/se knows how to get the necessary repairs done easily and conveniently by using a mobile mechanic, but is all too often wrong in such thinking, ultimately receiving potentially complex and important repair services both managed and performed by a typically young mechanic whose level of expertise is indicated by the fact that his/her time and skills warrant that he/she can spend time in travel instead of the intense and productive environment of a repair garage.

Just as Pogo by famous cartoonist Walt Kelley said “We have met the enemy and he is us”, the consumer of automobile repairs is his/her own worse enemy. And this problem—often resulting in dissatisfaction and tension—is not corrected by the convenience of a mobile mechanic. The system of the present invention is directed to getting a consumer of automobile repair services (1) those services that the consumer really truly needs, with (2) full understanding (insofar is proves possible, or the consumer desires) as to why he/she needs these services, both (3) efficiently and cost effectively, and thus (4) at a fair price. The system of the present invention can thus be fairly said to be “on the side of” the consumer. To warrant and to guarantee that it is so, the system will be seen to offer a separate warranty and guarantee to the consumer of auto repair services that necessary and prudent services only have been correctly performed at a fair price.

The present invention is embodied in a system, and in a business method, that serves to place an objective expert—a mobile vehicle diagnosis, and repair referral, service—on the side of the consumer auto owner.

2. The System of the Present Invention

In one of its aspects the present invention is embodied in a system for permitting an owner/operator of a vehicle needing repair to obtain repair of said vehicle. The system includes (1) a vehicular problem diagnosis and repair referral agency and (2) repair shops.

The (1) a vehicular problem diagnosis and repair referral agency has (1) mobile agents that can and do travel to vehicles needing repairs and diagnose the problems of said vehicles, (2) communications capability for communicating with customer vehicle owner/operators as to (2a) requests for diagnosis of, and referral of suitable repair services, for their vehicle needing repair, (2b) where and when is located said vehicle, (2c) negotiating a suitable time for diagnosis by a mobile agent, (2d) information on repairs diagnosed by a mobile agent as being needed, and (2e) one or more recommendations as to what repair shop or shops might suitably perform needed repairs and the cost estimate(s) therefore, (3) internal database creation and management capability to (3a) enroll various vehicle repair shops, (3b) supply to the customer lucid information of what repairs identified consist of and what it (they) should cost, and (3c) recommend to the customer repair shops suitable to perform the repair(s).

The repair shops are enrolled with the agency to accept referrals of vehicles needing repair, and contract with the agency to pay a referral fee—sometimes called a “commission”—for all referred vehicles upon which repairs are actually performed.

By these organizations and these coactions owner/operators of vehicles needing repair can contact the agency, arrange for and receive both a vehicle problem diagnosis and a cost estimate from a mobile agent, and proceed to have the repairs performed if they care to do so. The agency receives a fee from repair shops actually performing referred repairs, and only upon such occurrence(s),

The agency commonly also charges the owner/operators for the vehicle diagnosis performed. The agency normally permits a vehicle owner/operator so paying for vehicle diagnosis to communicate with the agency regarding any of the conduct, cost and satisfaction/dissatisfaction realized from any repairs actually performed by a recommended repair shop. This permitted communicating is typically by any of email, text message, or phone. It is normally unlimited in extent.

Most commonly the vehicular problem diagnosis agency can itself perform some repairs. Ergo the communicating with customer vehicle owner/operators as to where and when and by whom said diagnosed repairs might be obtained includes the identity of the agency itself.

Optionally the agency, or the repair shops, or both the agency and the repair shops can, and do, offer pick-up and delivery services to (1) retrieve a vehicle needing a diagnosed repair, (2) take it to be repaired by the agency or a repair shop approved by the owner/operator, anode (3) return the vehicle when repaired. Accordingly, an owner/operator exercising this option not be involved with taking the vehicle to and/or from repair.

In the preferred system of the invention the agency's mobile agents can, and do, also diagnose any outstanding maintenance requirements. In this case the agency's communication capability is also used to communicate any diagnosed outstanding maintenance requirements to the vehicle owner/operator.

The agency's communication capability also further serves to alert all repair shops that are recommended to the owner/operator (1) that they have been so recommended, (2) to who and when they have been so recommended, (3) what services on what vehicle it has been recommended that they should perform, and (4) what projected cost has been communicated to the owner/operator for these recommended services,

Normally the agency's mobile agents also diagnose any outstanding safety issues with the vehicles; and, accordingly, the agency's communication capability is also used to communicate any safety issues with the vehicle to the vehicle owner/operator.

The agency's mobile agents can and will perform, with authorization by the vehicle owner/operator, some repairs on the vehicle diagnosed.

Importantly for the businesses of the agency and the repair shops, the agency advises the vehicle owner/operator of his/her legal right to have repairs done by a repair shop of his/her choice regardless of any insurance and/or warranty on the vehicle needing repair. Many owners are not aware of their law-established, and contractual, rights to do so.

The agency commonly warrants all repairs ultimately timely made by any repair shop or shops recommended to the vehicle owner/operator. This warranty is normally secondary to the warranty(ies) on parts and/or services normally provided by the repair shops themselves.

3. The Business Method of Present Invention

In another of its aspects the present invention is embodied in a business method performed by a vehicle service agency providing service to an owner/operator of a vehicle needing repair.

The method includes (1) enrolling at and to the agency a multiplicity of vehicular repair service organizations; (2) receiving at the agency from an owner/operator(s) of a vehicle needing repair an electronically communicated request to provide assistance to said owner/operator(s) directed towards realizing repairs to the vehicle; (3) dispatching from the agency its mobile agent in a mobile diagnostic vehicle to the vehicle needing repair; whereupon arrival at the vehicle the mobile agent diagnoses any repair(s) needed by the vehicle; and then the mobile agent electronically communicates his diagnosis to the agency. The agency or the agent or both the agency and the agent (4) supply the vehicle owner/operator(s) with (4a) results of the diagnosis plus (4b) a recommendation, drawn from said multiplicity of vehicular repair service organizations, as to the identity of one or more of said multiplicity of vehicle repair service organizations where appropriate repair of the diagnosed problems of the diagnosed vehicle might suitably be obtained.

Upon so doing the agency (5) also alerts all enrolled vehicle repair service organizations identified to the owner/operator(s) of the diagnosed vehicle as to the identities of (5a) the diagnosed vehicle and (5b) the owner/operator(s) of the diagnosed vehicle, and (5c) the repair(s) diagnosed as being needed Ultimately the agency (6) receives reporting from such vehicular repair service organization(s) as was (were) alerted if and when it each did actually ever perform repairs on said diagnosed vehicle, and the monetary amount thereof this (these) repair(s); and, ultimately, (7) further receiving at the agency a referral fee from all said enrolled vehicular repair service organizations as do actually perform repairs on vehicles of owner/operator(s) to which they were referred by the agency.

The request(s) received at the agency are normally for repair a vehicle drawn from a class consisting essentially of cars and trucks.

The dispatching of a mobile agent is of a mobile agent that has expertise in diagnosing vehicles of the type identified to the agency from the owner/operator(s) of the vehicle.

The request(s) received at the agency are normally for repair a vehicle drawn from the class consisting essentially of (1) vehicles needing mechanical repairs to facilitate their further use, and (2) vehicles needing bodywork as affects their appearance. In such cases the dispatching of a mobile agent is of an mobile agent that has expertise directed to (1) mechanical repairs such as are needed by the vehicles needing mechanical repairs, or (2) vehicular bodywork such as is needed by the vehicles needing bodywork, as the case may be.

In the most preferred method the mobile agent will, after diagnosing any repair(s) needed by the vehicle, as a courtesy perfunctorily fix the vehicle if it can be readily be so done.

The agency or the mobile agent or both the agency and the mobile agent, as well as supplying the vehicle owner/operator(s) with (1) results of the diagnosis plus a recommendation to the identity of one or more vehicle repair service organizations where appropriate repair of the diagnosed problems of the might suitably be obtained, does (do) still further supply the vehicle owner/operator(s) with an estimate as to what the diagnosed problems should cost to repair. In order to best do so the mobile agent carries a mechanics standard schedule of charges, and/or a bodywork shop standard schedule of changes, or both, to use, as appropriate, in making his/her estimate.

The agency normally, and preferably, contracts to answer up to a predetermined number of electronic communications from the owner/operator(s) of a diagnosed vehicle towards the end of answering further questions the owner/operator(s) may have towards the end of effectuating satisfactory repair of the vehicle. These electronic communications are normally drawn from the group consisting essentially of (1) telephone calls, (2) text messages and (3) emails. Sometimes the owner/operator(s) is (are) permitted to have only two telephone calls answered, and to have only two emails responded to, by the agency per instance of vehicle diagnosed.

The vehicle diagnostic and repair referral service can be free to the owner/operator(s) of the diagnosed vehicle, but most commonly the vehicle diagnostic and repair referral service is at a predetermined fixed fee to the owner/operator(s) of the diagnosed vehicle. This fee is most typically circa 2017, about $100 U.S.

The mobile agent diagnosing repair(s) needed by the vehicle that are mechanical in nature uses a portable engine diagnostic system in so doing.

4. Synopsis of the System and the Business Method of the Present Invention

The system and business method of the present invention have (1) an independent business entity—called an “agency” because it ultimately serves as an agent of a vehicle owner/operator—and (2) a number of independent vehicular repair service organizations, in paid service to (3) an owner/operator of a vehicle suffering failure, and/or needing periodic scheduled maintenance.

In operation of the system, and the method, the (3) owner/operator of a vehicle suffering failure, or needing periodic scheduled maintenance, makes a request for assistance to (1) the agency. The agency has, and deploys in response to said request (1a) mobile agents that can and so travel to the vehicle needing repair(s), and there diagnose the problem(s) of said vehicle. The (1) agency also has (1b) computer databases for supporting the total correct procedural steps and parts required for rectification of the vehicle's problem(s), and generation of accurate estimates as to what these steps and parts necessary to effectuate vehicular repair(s) should and do cost. This exacting and complete repair information is provided to the (3) owner/operator of the vehicle, preferably and commonly while the (1a) mobile agent is still on site (if the owner/operator is with his/her vehicle). Further, exacting and complete repair cost information is provided to the (3) owner/operator of the vehicle by the (1) agency, although this estimate can take time and specialty expertise to generate (especially if involving collision damage) and is often delivered at a time or times only after the (1a) mobile agent has left the vehicle.

Still further, the (1) agency provides to the (3) owner/operator of the vehicle the names, addresses, contact numbers, available times, and, to such extent as the customer desires, qualifications and recommendations of certain then-selected one or ones of a large number of agency-enrolled (2) vehicular repair service organizations best able to competently, quickly, efficiently and satisfactorily repair the vehicle. It is explained to the (3) owner/operator that these are but recommended vehicular repair service organizations any one of which may estimate (and perform) necessary vehicle repairs at a cost greater or lesser, or greatly greater (or greatly lesser) than those preliminary estimates provided by the (1) agency to the (3) owner/operator. However, the customer is also informed that he will be accorded a limited number of contacts to, if desired, discuss with the agency any matters whatsoever, including matters of the repair service organization(s) to be used and cost estimates, regarding repairs. Still further, if the (3) owner/operator ultimately (within a prescribed set time period) uses one of the recommended (2) recommended vehicular repair service organization(s) then not only will the customer enjoy any warranty or guarantee on the work provided by said organization(s) but an additional, complimentary and complementary, warranty will be provided to the (3) owner/operator by the (1) agency! For example, this supplemental warranty may be complimentary in that if further related successor correction of repairs incorrectly or unsatisfactorily made becomes required then the agency will provide free concierge services to transport the vehicle.

Finally in the interface between the (1) agency and the (3) owner/operator of the vehicle, the (1) agency can optionally perform still more services, sometimes as are included within a base diagnostic and referral price without further charge. Sometimes, acting through its mobile representative, the (1) agency will itself perfunctorily effect needed vehicle repair(s), normally at but modest and competitive cost. Sometimes, and occasionally, the (1) agency will serve as a concierge serving to transport the vehicle to one of the (2) repair services organizations. The (1) agency normally maintains records, available at any time to the vehicle (3) owner/operator, of all repairs to, and maintenance performed on, the vehicle

Finally, in the system, and the business method, of the present invention (2) vehicular repair service organizations must be contractually enrolled in order to be recommended, and must normally meet high standards. These (2) vehicular repair service organizations (“repair shops”) receive formal notification—by any desired reasonable means of their choice, and most commonly by email—that they have been recommended to provide services to the (3) owner/operator of a vehicle needing repair. The (a) vehicle and its location are identified to them. So also are (b) the identity and contact information of the owner/operator of the vehicle, (c) what repairs are have been recommended for the vehicle, and (d) what these repairs have been projected to cost, given to those, and only those, repair service organizations so identified. Still other related information may be provided, all with the agreement of the vehicle owner/operator. E-mail may be used, but notifications can also be provided to the repair service organizations (“repair shops”) via an application that runs on the smart phones of these organizations.

The (2) vehicular repair service organizations (“repair shops”) have contractually agreed in advance to pay referral fees to the (1) agency in return for the agency's referral of all such vehicles for repairs as are actually subsequently performed within a prescribed, set, period, normally one year. Remittance of a referral fee, also called a commission, from (2) the repair shop to (1) the agency for repairs actually performed within this period—whether recommended and/or identified or not—is normally due within one month (30 days) from the time at which the repair shop is itself paid. This referral fee is normally a percentage of the total repair bill, both recommended repairs and incidental repairs and maintenance services, paid by the owner/operator to the (2) vehicular repair service organizations as a consequence of the referral. A typical percentage referral fee (commission) is 10%, which is a reasonable customer acquisition cost for a vehicular service organization (a “repair shop”).

5. The Practical Consequences of the Use of the Services of a Professional Agency in Vehicle Diagnosis, and Repair Referral

Most typically, only the diagnosis component of the agency services of the present invention is mobile, and even that sometimes for but a preliminary diagnosis. The core expertise of the service is, by and large, resident and performed at (1) a heavily computerized and expertly staffed dispatch and support agency central location, and (2) the agency uses each of specialty hardware, software, Internet communication, and skilled professional services to (1) demystify the auto repair industry, (2) permit the consumer to better understand the health and any problems of his/her auto, and (3) better establish a more transparent marketplace for local auto mechanics and body shops. Finally, and important, the agency refers the consumer owner of the vehicle to at least two honest and capable service organizations that are best calculated to successfully repair the vehicle.

The business method of the present invention is quite effective to intelligently diagnose and repair new (circa 2017) self-driving vehicles that “live in the wild”—meaning that they are preferably always on the streets of an urban area. These vehicles are commonly ultimately owned by municipalities and/or service organizations like as to public utilities. They are—other than for regularly scheduled preventive maintenance—preferably not returned to some one central location, or garage, every single time vehicle telecommunications, and (self-driving) usage history indicates that something is wrong with the vehicle. It is advanced that the present invention answers the question as to who fixes problems, and how, in a vehicle that is in public service, and that is not only not “owned” by any particular individual(s), but, indeed, no one is likely to give a damn about the (any) (particular) vehicle, and simply “kicks it to the curb” to provide, with its accrued and continuing problems unresolved, poor service to the next party in line.

The system of the present invention can obviously reply to automated vehicle-computer-generated, alerts. If an autonomous vehicle self-reports itself as suffering an engine warning light the agency of the present invention can be contracted by the vehicle owner to go out to the vehicle, find out what is wrong, and to dispatch the vehicle (if mobile and if safe possibly via its self-driving feature) to the appropriate owner-designated repair shop (possibly the owner's own) for necessary repairs.

6. The Effect of the Business Method of the Present Invention

As regards its embodiment as a business method, the present invention contemplates (1) informing—by on-location diagnosis of a vehicle needing repairs—the owner/operator of the vehicle as to what repairs, exactly, the vehicle appears to need, and (2) referring the owner/operator to at least one, and more preferably, two repair service organizations well-calculated to be able to competently perform the needed repairs.

The present invention further contemplates the use a central agency to market and promote the vehicular repair services of different and independent vehicular repair service organizations to vehicle owner/operators needing these services. Moreover, this marketing and promotion is most preferably done so as to best match the repairs needed by a particular vehicle to the repair service organization best performing this (these) repairs. In this determination “best’ is broadly interpreted relative to (1) the preference(s) of the owner/operator of the vehicle, (2) expertise and preference(s) of the various repair service organizations, (3) relative geographical locations and schedules of the vehicle needing repair and the repair service organizations best calculated to perform these repairs, and (4) still other factors.

The method of the present invention will be seen to be eminently suitable to a future (relative to 2017) in which there are self-driving cans and trucks, including such as may be used in common as a municipal service, and/or rented from non-centralized locations, for providing transportation service within, most likely, a municipal area. The present invention answers the question: “When the driver does not own the self-driving car, how do problems with the car get recognized, and how does the car get fixed?”

For example, an “urban fleet” motor vehicle picked up literally off the street by some temporary renter/user thereof may turn out not be running well. Upon conclusion of use and/or rental, the renter/user may choose to leave a comment so indicating with the organization controlling the self-driving vehicle. This organization could then engage the agency contemplated by the present invention to send the agent contemplated by the present invention (1) to travel to the vehicle and (2) to check it out. This is because it would be unsuitable to attempt to have an unsafe or unsound vehicle drive itself to some central garage. The vehicle diagnosis report of the agent being received by the agency, and forwarded to the organization controlling the self-driving vehicle, this organization would immediately decide what to do (or have previously delegated this power to the agency). For example, the controlling organization would authorize the agent to program the subject vehicle then and there to drive itself to a chosen appropriate location for repair For example, the controlling organization could authorize the agent to send for a wrecker, or do so itself. For example the controlling organization could ask the agent to hook up the inoperative or unsafe self-driving car and tow it to an agreed-upon location, likely for repair or scrap.

The organization controlling the rental car can of course do this support for deployed self-driving cars itself. The simple reason that it would instead use an agency is that the agency services other accounts, and even individuals, so as to make much more efficient the travel and the time of its agents in the field in attempting to timely diagnose vehicle problems, and to timely direct them to repair. The first agency performing this service within any particular metropolitan area could likely establish a natural monopoly.

7. Various Further Aspects of the Preferred Embodiment of the Business Method of the Present Invention

In one of its aspects the present invention is embodied in a method of making targeted referrals to the owner/operator of a vehicle needing repairs to at least one vehicular repair service organization well calculated to be able to perform necessary repair. The method starts by enrolling at and to an agency a multiplicity of vehicular repair service organizations. These organizations are normally willing to so enroll because, as will later be seen, they can preferably do so at no cost save that they must ultimately pay a referral fee, preferably calculated as a percentage of actual billings, on any referred vehicular repairs ultimately actually performed.

Continuing, the agency receives a request from an owner/operator of a vehicle needing repairs to provide assistance to he/she/them directed towards realizing said repairs. Responsively to this request the agency dispatches its own agent in a mobile diagnostic vehicle to the vehicle needing repair.

Reaching the subject vehicle, the agent diagnoses any repair(s) needed by the vehicle. He/she then supplies the vehicle owner/operator(s) with (1) results of the diagnosis plus (2) a recommendation, drawn from said multiplicity of vehicular repair service organizations, as to the identity of one or more vehicle repair service organizations where appropriate repair of the diagnosed problems of the diagnosed vehicle might suitably be obtained.

The agency then alerts all enrolled vehicle repair service organizations identified to the owner/operator(s) of the diagnosed vehicle as to the identities of the diagnosed vehicle and of the owner/operator(s) of the diagnosed vehicle, and the repair(s) diagnosed as being needed.

If and only if any of these vehicular repair service organization(s) as was (were) alerted do actually ever perform repairs on said diagnosed vehicle, then this fact, and the monetary amount thereof the repair, is reported by the vehicular service repair organization (s) performing the repairs to the agency.

Ultimately the agency further receives a referral fee from enrolled vehicular repair service organizations that do actually perform repairs on vehicles of owner/operator(s) to which they were referred by the agency.

The request received at the agency is for repair of a vehicle is most commonly drawn from the class consisting essentially of cars and trucks. The dispatching of an agent is then most commonly of an agent that has expertise in the vehicle identified to be a car or a truck as the case may be.

Similarly, the request received at the agency can be either for repair a vehicle drawn from the class consisting essentially of (1) vehicles needing mechanical repairs to their mobility, and (2) vehicles needing bodywork as affects their appearance. In this case the dispatching of an agent is of an agent that has expertise directed to (1) mechanical repairs as are needed by a vehicle needing mechanical repairs, or (2) vehicular bodywork as is needed by a vehicle so needing bodywork, as the case may be.

Most often, and as courtesy to the customer owner operator, after diagnosing any repair(s) needed by the vehicle, the agent will, as a courtesy, perfunctorily fix the vehicle if it can be readily and easily so done. This would include situations like inflating a flat tire, or jump starting the vehicle.

The agent—as well as supplying the vehicle owner/operator(s) with (1) results of the diagnosis plus a recommendation to the identity of one or more vehicle repair service organizations where appropriate repair of the diagnosed problems of the might suitably be obtained—may still further supply the vehicle owner/operator with an estimate as to what the diagnosed problems should cost to repair. To this end the agent can carry a mechanics standard schedule of charges, and/or a bodywork shop standard schedule of changes to use, as appropriate, in making his/her estimate.

The agency can, and preferably will, permit of answering a predetermined number of communications from the owner/operator(s) of a diagnosed vehicle towards the end of answering further questions the owner/operator(s) may have, and effectuating satisfactory repair of the vehicle. These communications are normally in the form of (1) telephone calls and (2) emails. One permission might be, for example, that the owner/operator is permitted two telephone calls, and to have two emails responded to, by the agency per instance of vehicle diagnosed.

This vehicle diagnostic and repair referral service can be offered free to the owner/operator(s) of the diagnosed vehicle, but most commonly, and most preferably, the vehicle diagnostic and repair referral service is at a predetermined fixed fee to the owner/operator(s) of the diagnosed vehicle.

These and other aspects of the present invention will become increasingly clear upon reference to the following drawings and accompanying specification

### BRIEF DESCRIPTION OF THE DRAWINGS

FIG. 1 is a block diagram showing participants, and message traffic, in the system and method of the present invention.

FIG. 2 is a screen shot of an exemplary screen displayed to a potential client-user of the system of the present invention upon the client-user reaching with his/her browser the home page of the Internet web site of the system.

FIG. 3 is a screen shot showing an exemplary screen that is reached upon click through from the screen of FIG. 2; the screen offering an exemplary clickable menu of some four choices of interaction with the system.

FIG. 4 is a screen shot of an exemplary screen that is reached upon clicking the choice of “New Request” in the precious screen shown in FIG. 3; this new screen permitting a new client-user to start to provide data to enroll in the system of the present invention.

FIG. 5 is a screen shot of an exemplary screen that pops up over the screen previously shown in FIG. 4, the pop-up asking for permission to identify the location of the person entering the “Contact Person” data.

FIG. 6 is a screen shot of another view of the same screen previously shown in FIG. 5 the screen now showing exemplary entered client-user personal data.

FIG. 7 is a screen shot of an exemplary screen, accessed upon completion of the screen previously shown in FIG. 6, where a client-user can enter data about the car now needing diagnosis and, most likely, repair, the MOBI system responding with suggested services that can be provided for the identified vehicle.

FIG. 8 is a screen shot of an exemplary screen showing where a client-user previously known to the MOBI system may see his/her vehicles displayed, and enter new or revised vehicle data.

FIG. 9 is a screen shot of an exemplary screen where a client-user may enter still further data regarding the particular vehicle that is the subject of the present request.

FIG. 10 is a screen shot of an exemplary screen where a client-user may select from a checklist of popular inspections, diagnosis, and services that are requested to be performed on the particular vehicle that is the subject of the present request.

FIG. 11 is a screen shot of an exemplary screen where a client-user specifies a particular inspection, diagnosis and/or service that (is) are requested to be performed on the particular vehicle that is the subject of the present request.

FIG. 12 is a screen shot of an exemplary screen where a client-user can propose a date upon which services are requested to be performed on the particular vehicle that is the subject of the present request.

FIG. 13 is a screen shot showing an exemplary screen where a client-user can propose a time at which services are requested to be performed on the particular vehicle at the particular date selected in the screen shown in FIG. 12.

FIGS. 14 and 15 are screen shots showing exemplary screens where a client-user is confirmed in his/her proposal of a date and a tine at which services are to be performed.

FIG. 16 is a screen shot showing an exemplary screen showing that the client-users proposal of date and tine is confirmed the particular date selected in the screen shown in FIG. 14.

FIG. 17 is a screen shot showing an exemplary screen showing location data on the concierge, called “MOBI”, of the present invention.

FIG. 18 is a screen shot showing an exemplary screen showing history data on the concierge, called “MOBI”, of the present invention.

FIG. 19 is a screen shot showing an exemplary screen showing exemplary terms and conditions of the concierge, called “MOBI”, of the present invention.

FIG. 20 is a screen shot of the then cumulative requests of a particular owner/driver client.

FIG. 21 is a screen shot showing an exemplary home, log in, screen of a computer monitor of the computerized diagnosis and referral system of the present invention as running at a central office of the concierge agency called “MOBI”.

FIG. 22 is a screen shot showing an exemplary log-in screen of the computerized diagnosis and referral system of the present invention as running at a central office of the concierge agency called “MOBI”.

FIG. 23 is a screen shot showing a screen of exemplary pending present activity within the computerized diagnosis and referral system of the present invention as running at a central office of the concierge called “MOB”.

FIG. 24 is a screen shot showing an exemplary administrative screen of the computerized diagnosis and referral system of the present invention as running at a central office of the concierge called “MOBI”, the screen for managing client-user data for a particular incident, and partially filled in by an administrator with exemplary data.

FIG. 25 is a screen shot showing the exemplary administrative screen of the computerized diagnosis and referral system previously seen in FIG. 24, the screen now completely filled in by an administrator with exemplary data.

FIG. 26 is a screen shot of the exemplary administrative screen previously seen in FIG. 23, the screen now further filled in by an administrator.

FIG. 27 is a screen shot of the exemplary administrative screen previously seen in FIG. 25, the screen now further filled in by an administrator.

FIG. 28 is a screen shot of the exemplary administrative screen previously seen in FIG. 26, the screen now further filled in by an administrator.

FIG. 29 is a screen shot of the exemplary administrative screen previously seen in FIG. 28, the screen now further filled in by an administrator.

FIG. 30 is a screen shot of the exemplary administrative screen previously seen in FIG. 27, the screen now further filled in by an administrator.

### DESCRIPTION OF THE PREFERRED EMBODIMENT

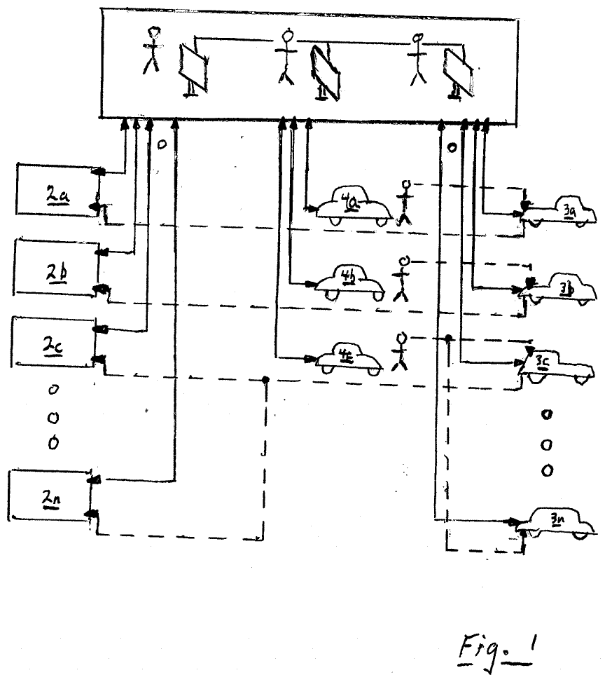

A block diagram showing participants, and message traffic, in the business method of the present invention is shown in FIG. 1. A manned computerized concierge central agency office 1 with people 1a and computers 1b has contractually enrolled a number of vehicular repair service organizations (“repair shops”) 2a-2n that meet its standards. These vehicular repair service organizations 2a-2n may each offer any combination of mechanical repair and/or maintenance services and/or paint and bodywork services. All work must be warranted and guaranteed per best industry practices, and the concierge central office will ultimately help referred consumers in enforcing these guarantees if necessary.

In return for referrals of appropriate work (to be explained) the vehicular repair service organizations 2a-2n (1) pledge to deal honestly and fairly with referred customers 3a-3n, (2) agree that the concierge central office 1 can gather information about their performance on their pledges to so deal, and (3) agree that the concierge central office 1 can publish gathered information. In return for referred business, the vehicular repair service organizations 2a-2n pay a contingent fee to the concierge central office 1, normally a percentage of billings (nominally 10%) for work actually performed (whether previously estimated or not) within a set period of time (normally 2 months) for only such ones of customers 2a-2n as are in fact referred, and which actually have work done.

The services of the computerized concierge agency central office 1 come to the attention of the owner-operators (the “customers”) 2a-2n via normal promotional and marketing means, news media, a concierge website, a smart phone application, consumer referral, and the like. Concierge agency central office 1 advertising goes something like as follows:

“Do you have or suspect that you have car trouble? We can help you to diagnose the problems with your car, and its overall health. We will intelligibly communicate our findings to you, and provide you with at least two recommendations—drawn from our knowledge of literally hundreds of vehicular repair organizations—as to where, by whom, and how you might best and most economically get your car excellently repaired . . . .

“We are on YOUR side. We will help you telephonically contact an appropriate vehicular repair organization right there, right now if you wish. We will help you ask the appropriate questions. Whether you avail yourself of our instant assistance in making a necessary appointment or not, we will make sure all necessary information from out diagnosis performs gets to all service organizations that we recommend to you. This saves you time. It saves them time.”

“If you want we will arrange at extra cost to come and pick up your car, take it to be repaired, and return it at a time and location of your choosing. You will be contacted by means of your choosing for your consent and approval before any repairs are performed,

“We will accord you one phone call with our office representative BEFORE services are performed, and one AFTER services are performed, to discuss anything that you want. Before services are performed, you may wish to again discuss our findings, discuss any repair(s).”

Continuing in FIG. 1, upon receiving a request for concierge services, and prepayment of a fixed amount (nominally $100 circa 2017), the concierge agency central office 1 will dispatch and appropriate one of Mobile Diagnostic Service Representatives (“MDSR”) 4a-4c each in a fully equipped diagnostic van by communication along an appropriate path 14a-14c. A Mobile Diagnostic Service Representative that is appropriate in each of (1) location, (2) schedule, (3) competence and tools, will be directed to go to a selected customer can 3a-3n at a prearranged time and location. The owner user-customer 3a-3n may be present or not for a scheduled appointment or not. For example, Mobile Diagnostic Service Representative 4b can travel to customer vehicle 3b by path 4c3b, as illustrated.

The Mobile Diagnostic Service Representative (“MDSR”) 4a-4c will check out the car, evaluating the roadworthiness of the car including by driving it, and will look beyond merely such problems as are reported by the owner/operator (i.e., the customer). The MDSR will evaluate brakes and traction control; he/she will look for the need for parking brake cable replacement, parking brake switch replacement, and brake master cylinder replacement. He/she will perform a brake safety inspection by checking brake fluid level, and looking for any need for brake caliper replacement, bleeding of the brakes, and/or brake fluid flush. He/she will assess any need for booster replacement, brake pads replacement, brake drum replacement, brake shoes replacement, brake pedal linkage lubrication, brake adjustment, brake rotor replacement.

The DSR will perform a diagnostic of the vehicle and its engine. He/she will analyze the reason(s) for any occurrences of the check engine light, car won't start, car running rough, fluids are leaking, and/or any warning light.

The DSR will evaluate the engine, cooling, and exhaust systems of the vehicle. He/she will assess the need for front pipe replacement, fan shroud assembly replacement, idle control valve replacement, fan shroud replacement, distributor replacement, EGR valve replacement, ignition wire set replacement, cooling system and fill, oil pan gasket replacement, intake manifold gasket replacement, spark plug replacement, exhaust manifold gasket replacement. He/she will still further diagnose any need for tail pipe replacement, carburetor replacement, exhaust system replacement, manual transmission oil level check, check engine oil level, engine oil and filter change, expansion tank replacement, harmonic balancer replacement, serpentine belt replacement, distributor cap replacement, cooling fan replacement, radiator replacement, thermostat replacement, and/or engine tune-up.

The MDSR will assess the need for external vehicle parts including any need for antenna mast replacement, mirror glass replacement, door lock replacement, headlight door replacement, header panel replacement, license plate bracket replacement, emblem replacement, metal license plate bracket replacement, trunk strut replacement, grille insert replacement, engine splash shield replacement, fuel tank cap replacement, hood strut replacement, splash guard backing plate replacement, rear lift gate locking mechanism, rear distance sensor replacement, door weather stripping replacement, power seat switch replacement, and/or energy absorber replacement.

The MDSR will assess the vehicle heating and air conditioning, blower motor resistor replacement, heater core replacement, cabin air filter replacement, heater and a/c blower motor, a/c recharge, a/c compressor replacement, a/c condenser replacement, defroster grid repair, a/c line or hose replacement, and/or heater core hoses replacement.

The MDSR will assess the vehicle lighting and horns. He/she will assess the need for turn signal switch replacement, turn signal bulb replacement, brake light bulb replacement, headlight bulb replacement, fog light assembly replacement, corner light bulb replacement, side marker light assembly replacement, turn signal light assembly replacement, headlight assembly replacement, park light assembly replacement, headlight cover, tail light bulb replacement, tail light assembly replacement, brake light switch replacement, headlight switch.

The MDSR will assess the vehicle maintenance history including as may regard, fuse replacement, tires rotation and scheduled maintenance such as that which typically occurs at 30 k, 60 k, 90 k, miles etc.

The MDSR will assess the vehicle power train. He/she will assess the need for throttle body replacement, throttle position sensor replacement, oxygen sensor replacement, fuel injector replacement, fuel filter replacement, air filter replacement, air flow sensor/meter replacement, fuel pressure regulator replacement, ignition coil replacement, spark plugs replacement.

The MDSR will assess the vehicle starting and charging ignition switch replacement, battery replacement, alternator belt replacement, alternator replacement, starter replacement.

The MDSR will assess the vehicle steering and suspension, power steering hose replacement, power steering fluid drain and fill, outer tie rod end replacement, power steering pump replacement, wheel hub assembly replacement, control arm replacement, check tire pressure, check power steering fluid, power steering fluid replacement, wheel bearing replacement, abs control unit replacement, wheel cylinder replacement, ball joint replacement, shock absorber replacement,

The MDSR will assess the vehicle transmission and drive train. He/she will look for any need for axle assembly replacement, CV boot replacement, CV joint replacement, drive shaft replacement, transfer case fluid replacement, and/or transmission fluid change.

The MDSR will assess the vehicle windows and glass. He/she will look for the need from window regulator with motor replacement, window belt strip replacement, and power window switch replacement.

The MDSR will assess the vehicle and washer system. He/she will look for the need for windshield wiper motor replacement, windshield wiper blades replacement, and washer pump replacement

The MDSR fills out a form on a computer as he/she completes his/her stepwise evaluation. If any simple thing such as, most commonly, the rendering of a jump start, or providing some emergency fuel, is done (which is in any case necessary to start the car for evaluation) then this also is noted, and is normally performed for no extra charge. The form results of the analysis are printed out directly from a printer in the van of the mobile MDSR, and are also telecommunicated back to the concierge central office 1. The concierge agency central office 1 having superior knowledge of the locations, availability, and expertise of the various vehicular repair service organizations 2a-2n appropriate to the problems it now sees itemized, immediately responds with at least two itemized and extended explanatory recommendations as to where the now-diagnosed problems might best be repaired, and this also is printed out and given to the customer.

To such extent he/she is competent to do so, the DSR 4a-4n will discuss both his/her (1) diagnostic findings, and (2) repair recommendations with the customer 3a-3n if he/she be present. The customer 3a/3n will in any case get an emailed copy of said (1) diagnostic findings, and (2) repair recommendations. He/she is entitled a predetermined number of free telephone calls—normally two such—to the concierge central office 1 to discuss anything that he or she wants, normally the report and its recommendations. The customer is invited to call once about any repair estimates he or she receives, normally the concierge agency central office 1 can but provide a voice of reassurance, and reason, to the customer regarding any repair estimates that he/she is ultimately received from enrolled vehicular repair service organizations 2a-2n, or other organizations. However, in rare cases independent advice can be provided to the customer, such as advice to sell, or to junk, the vehicle needing repairs. This advice, and the customer's subsequent contact, is in no manner deceitful. The customer has paid for, and has received, an honest and candid evaluation of problems with his/her vehicle, and if he/she decides to trade it in to an auto dealer instead of repairing it, then it is up to said auto dealer to protect itself, which it is fully capable of doing.

Finally, the vehicular repair service organizations 2a-2n that have been recommended to perform repairs are alerted of those specific vehicles to which their services have been recommended, and are accorded a full copy of the report the DSR has generated on the vehicle. Vehicular repair service organizations 2a-2n are alerted, and do agree, that this diagnostic report may be flat wrong, and that they must diagnose the vehicle themselves (should they be called upon to do so) in accordance with all normal standards. If, and only if, the specific vehicle is rendered repairs of any nature, not limited to diagnosed conditions, within a fixed period, normally three months, then a percentage, nominally 10% of the total charges made and collected for all repairs (ex of tax), is remitted as a referral fee (also called “a commission”) to the agency concierge central office 1

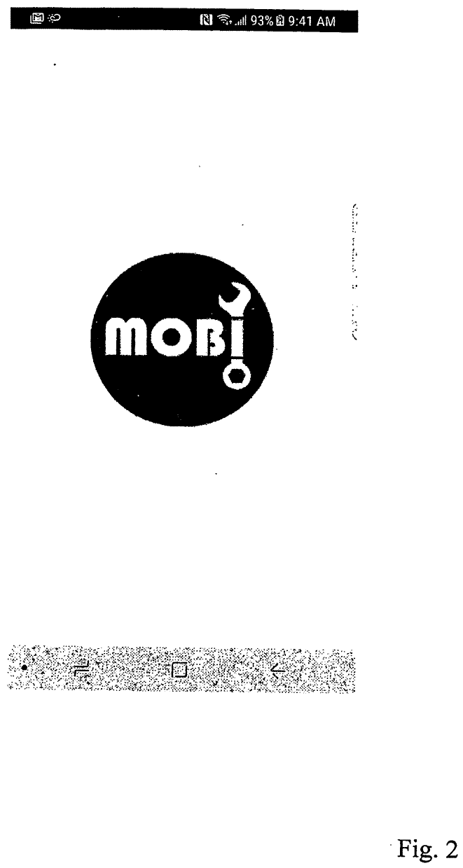

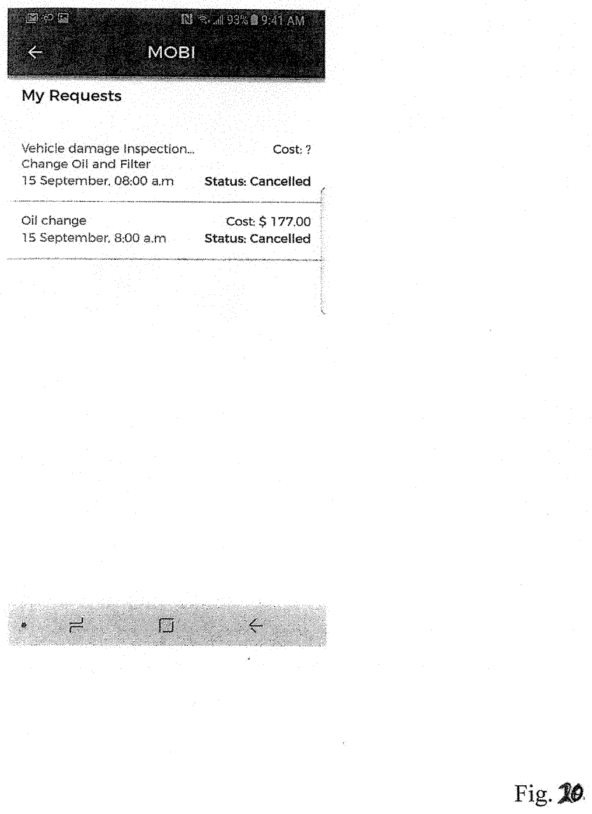

Pictures of the various cell phone screens attending major communications transpiring within the preferred embodiment of the various present invention are shown in FIGS. 2-20. There are other communications transpiring including (1) voice that can transpire over the telephone and/or face to face, and (2) and email that can also transpire over a smart phone (as well as a computer or tablet), in the preferred system. These communications are discussed after discussion of FIG. 20. However, in general communications in the system of the present invention are by presentation of, and entry of data upon, the screens of a smart phone.

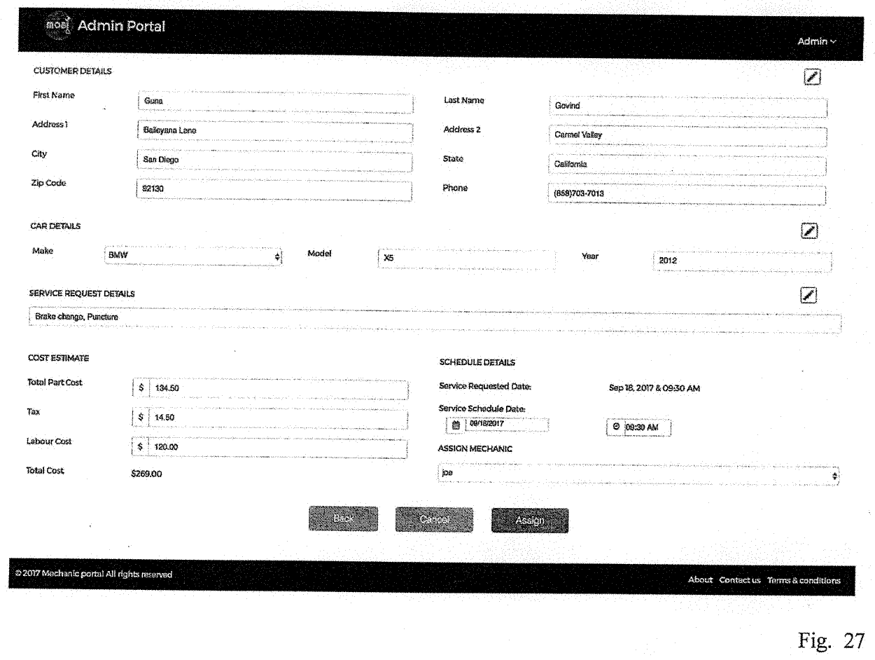

Pictures of the various screens that appear on a computer monitor of the computerized diagnosis and referral system of the present invention as running at a central agency office of the concierge, arbitrarily called “MOBI” appear at FIGS. 20-29. These screens interact with the screens of FIGS. 2-13 presented the client-user to transfer the data necessary to realize the purposes of the present invention.

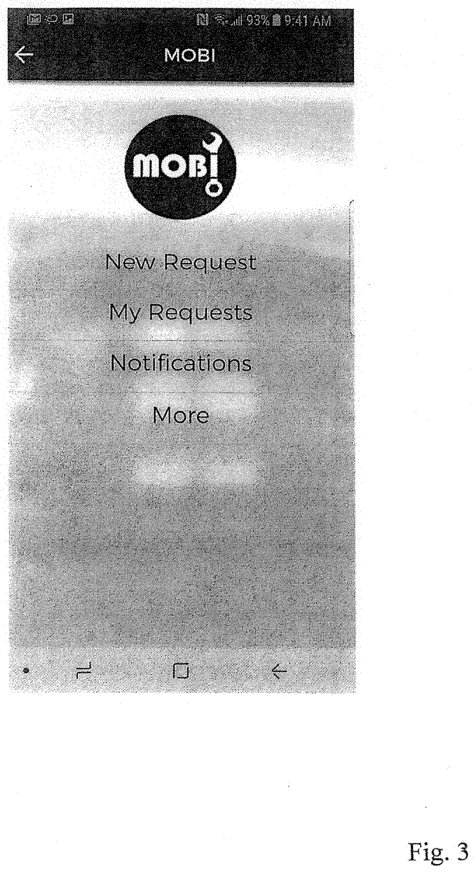

An exemplary first screen displayed to a potential client-user of the system of the present invention upon the client-user reaching with his/her browser the home page of the Internet web site of the system is shown in FIG. 2. This screen, and others of FIGS. 3-19, are in the aspect ratio of a smart phone, and show accompanying header and footer fields as are typical of a smart phone. The system, and home page of the website, of the present invention may be exercised by any device capable of communicating upon the Internet. The name “MOBI” is arbitrary for the system and method of the present invention, and is reminiscent of the mobile aspects of the services provided.

A screen shot showing an exemplary screen that is reached upon client-user click through from the screen of FIG. 2 is shown ion FIG. 3. The screen offers an exemplary clickable menu of some four choices of interaction with the system.

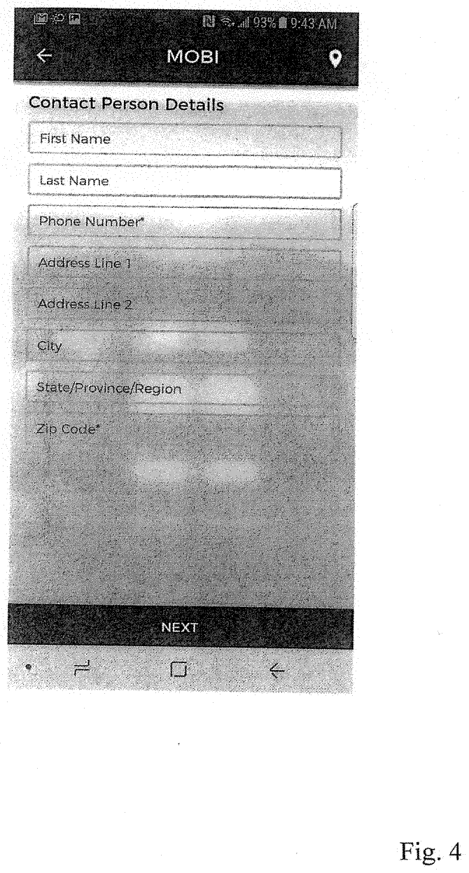

A screen shot of an exemplary screen that is reached upon clicking the choice of “New Request” in the precious screen shown in FIG. 3 is shown in FIG. 4. This new screen permits a new client-user to start to provide data to enroll in the system of the present invention. Its completion is mandatory to continue to make a request,

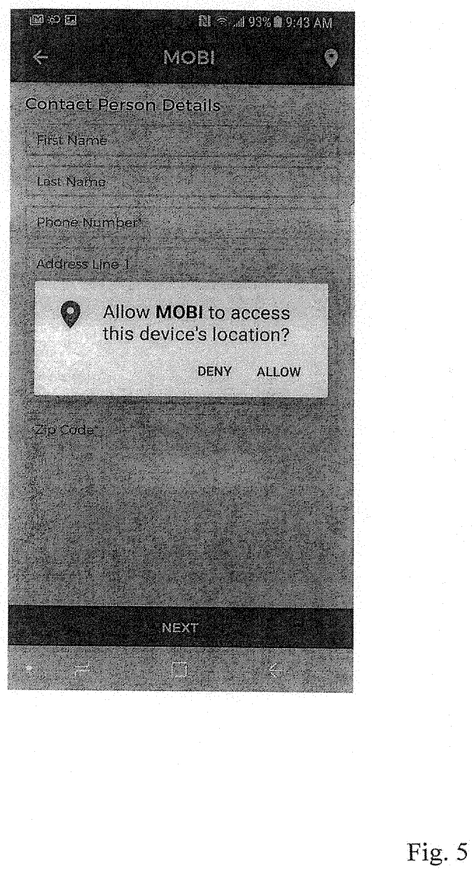

A screen shot of an exemplary screen that pops up over the screen previously shown in FIG. 4 is shown in FIG. 5. The pop-up screen asks for permission to identify the location of the person entering the “Contact Person” data. If the answer is positive the system will use conventional means to approximately locate the user by the Internet Service Provider (“ISP”) he/she is using to connect to the MOBI system.

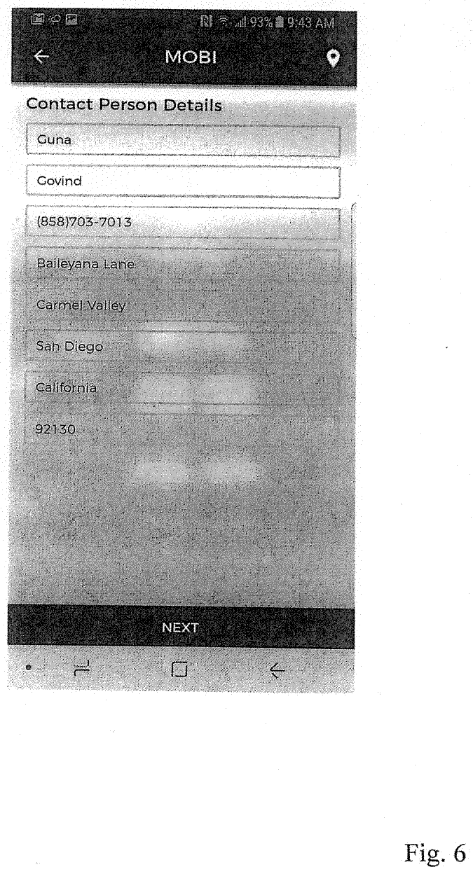

A screen shot of another view of the same screen previously shown in FIG. 5 is shown in FIG. 6. The screen now shows exemplary entered client-user personal data.

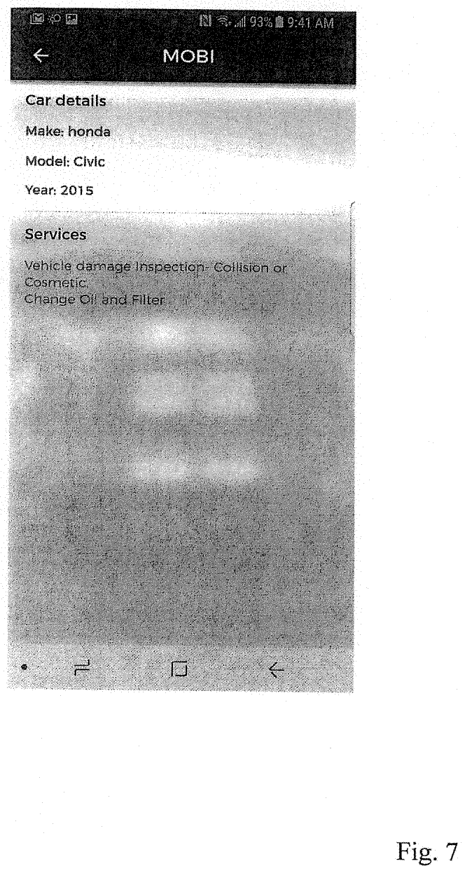

A screen shot of an exemplary screen, accessed upon completion of the screen previously shown in FIG. 6, is shown in FIG. 7. In this screen a client-user can enter data about the car now needing diagnosis and, most likely, repair. Upon completion of this screen the MOBI system will respond with a screen suggesting services that can be provided for the identified vehicle.

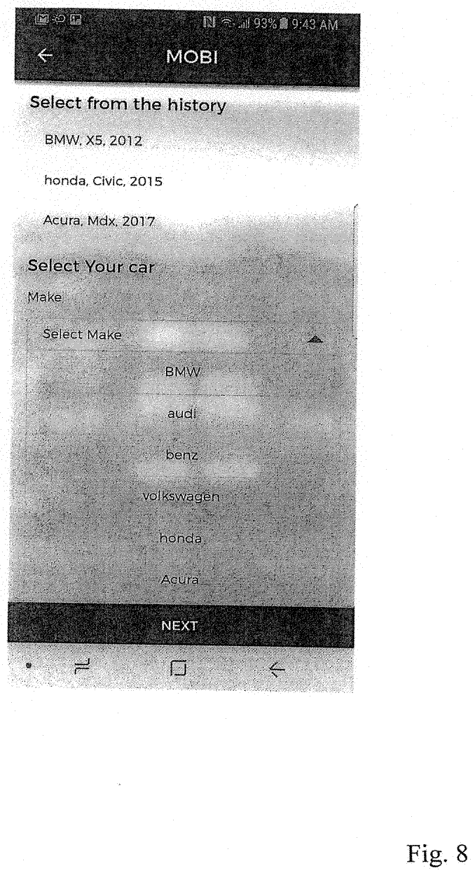

A screen shot of an exemplary screen showing where a client-user previously known to the MOBI system may see his/her vehicles displayed, and may enter as required or desired new or revised vehicle data, is shown in FIG. 8.

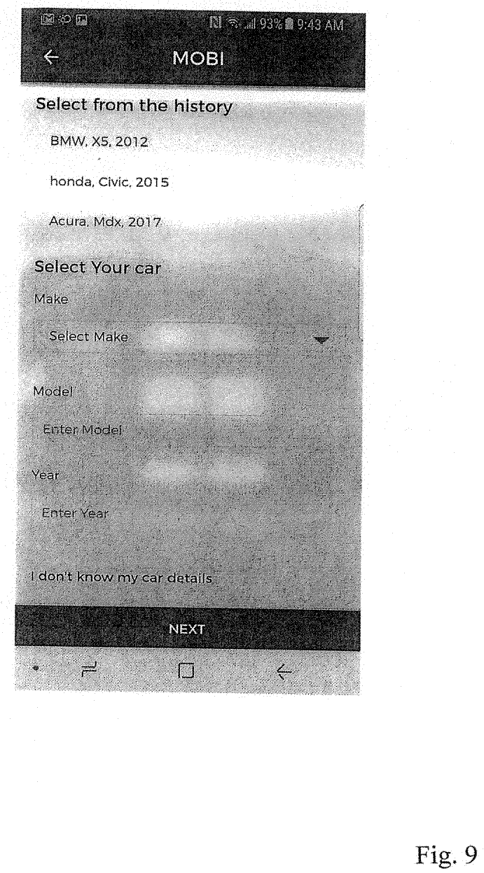

A screen shot of an exemplary screen where a client-user may enter still further data regarding the particular vehicle that is the subject of the present request is shown in FIG. 9. Normally these and still other screens need not be completely nor accurately entered in order to progress in the system. Uncompleted and/or inaccurate entered screen data simply means that a human representative, called an “administrator”, of the MOBI system will ultimately have to complete the information in dialog with the client-user,

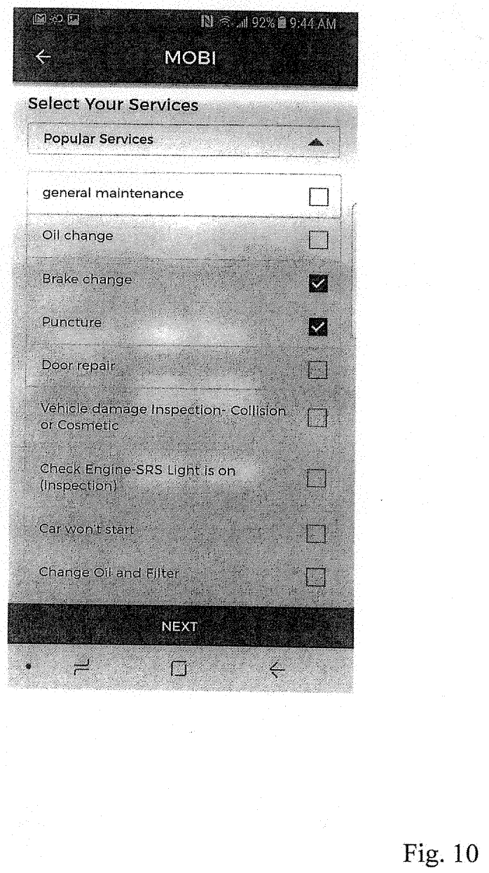

A screen shot of an exemplary screen where a client-user may select from a checklist of popular inspections, diagnosis, and services that are requested to be performed on the particular vehicle that is the subject of the present request, is shown in FIG. 10. This screen is used, and considered, by an “administrator” of the MOBI system viewing the screen to only suggest what the client-user thinks that his/her vehicle needs. Later, during vehicle inspection and diagnosis, the human MDSR will identify to the client-user those services that his/her vehicle does not indeed need, and other services not identified that the vehicle may need, and sometimes critically so.

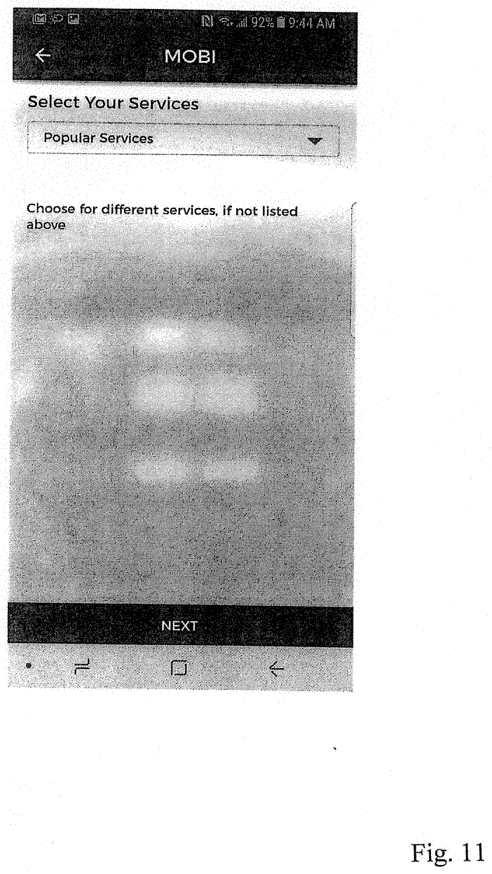

A screen shot of an exemplary screen where a client-user specifies a particular inspection(s), diagnosis and/or service that (is) are requested to be performed on the particular vehicle that is the subject of the present request is shown in FIG. 11. The inspection is never limited to those matters specified. The list simply reflects what the client-user thinks is wrong with, or needs be done, for his/her vehicle.

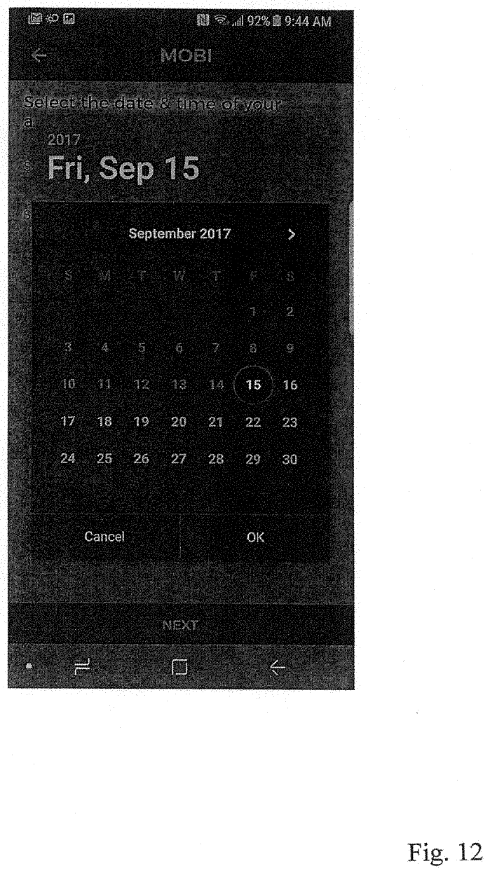

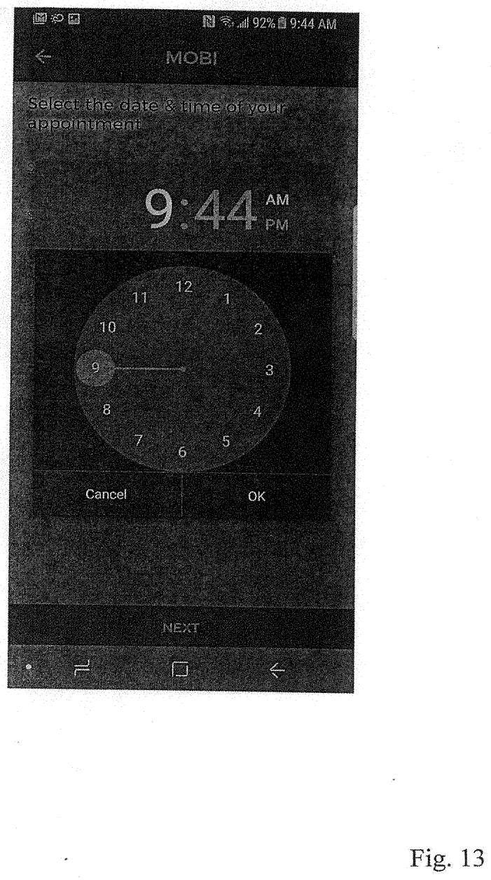

A screen shot of an exemplary screen where a client-user can propose a date upon which services are requested to be performed on the particular vehicle that is the subject of the present request is shown in FIG. 12. A screen shot showing an exemplary screen where a client-user can propose a time at which services are requested to be performed on the particular vehicle at the particular date selected in the screen shown in FIG. 12 is shown in FIG. 13,

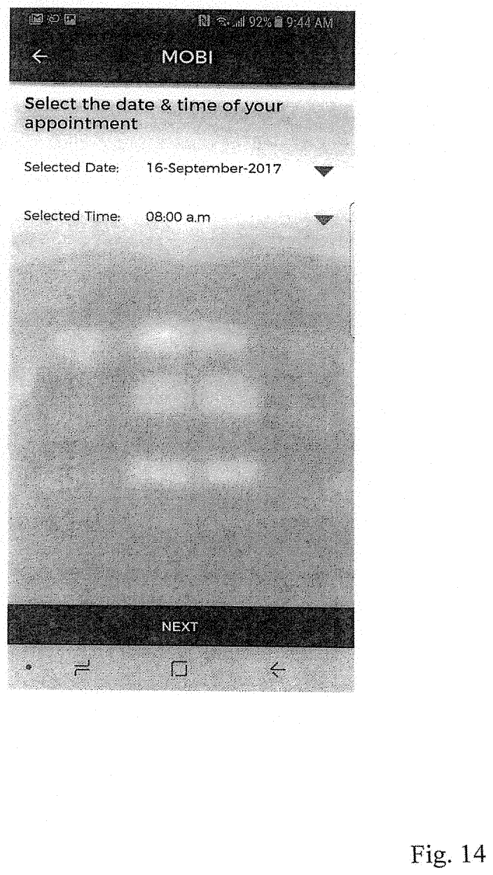

A screen shot showing an exemplary screen where the client-user proposed date and a tine at which services are requested to be performed is shown in FIG. 14.

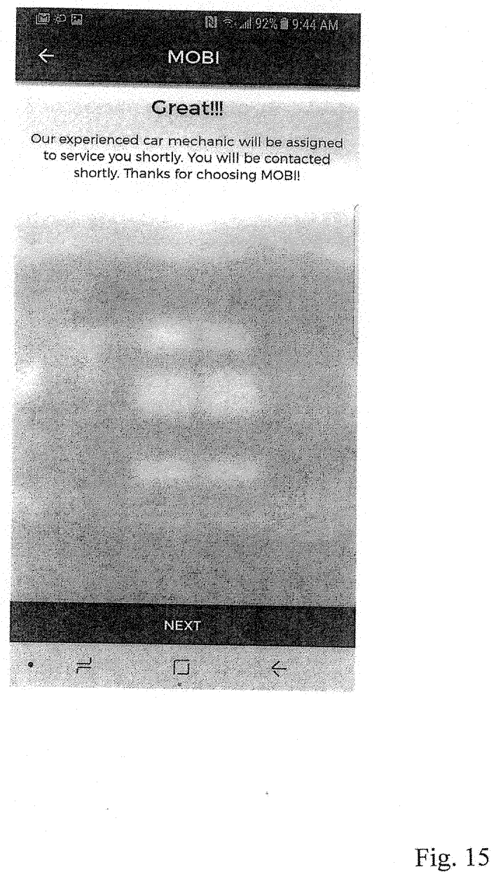

A screen shot showing an exemplary screen showing that the client-user's proposal of date and tine of the screen shown in FIG. 14 is confirmed is shown in FIG. 15. If not confirmed the client-user will be asked to submit further choices, all by action of a human administrator at the MOBI concierge agency service organization.

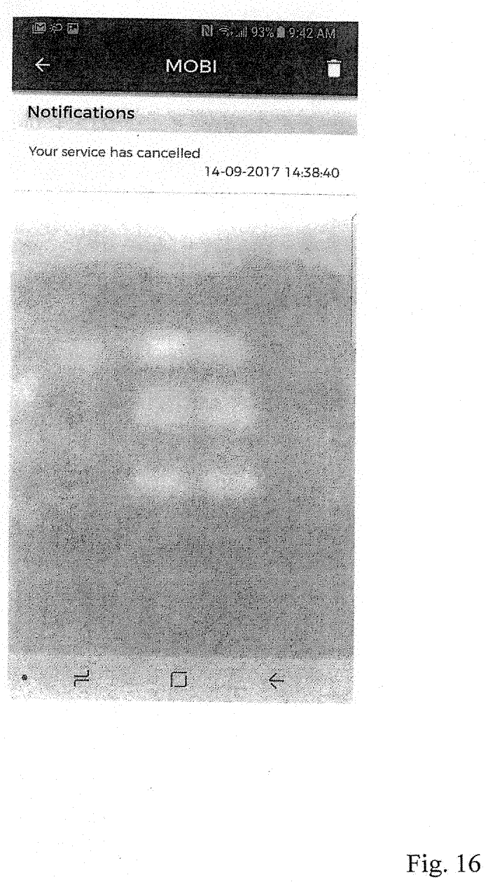

If the choice “My Requests” is selected by the client-user in the screen shown in FIG. 3 then the client-user will be presented with the screen shown on FIG. 16. This screen shows the status of all current requests for all vehicles of this particular. It normally goes back in time for a predetermined period, normally one month.

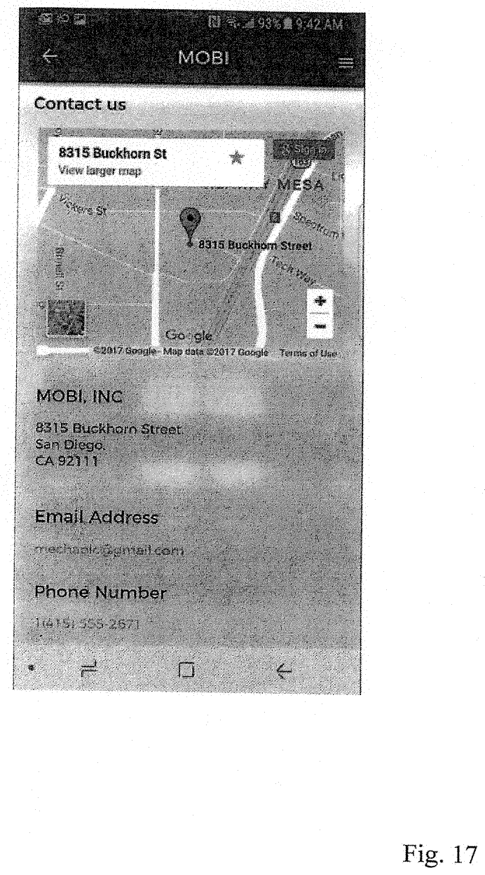

If the choice “Notifications” is selected by the client-user in the screen shown in FIG. 3 then the client-user will be presented with the screen shown on FIG. 17. This screen shows notifications to the client-user about his services both scheduled and performed, and notification(s) of any other message(s) sent such as by email.

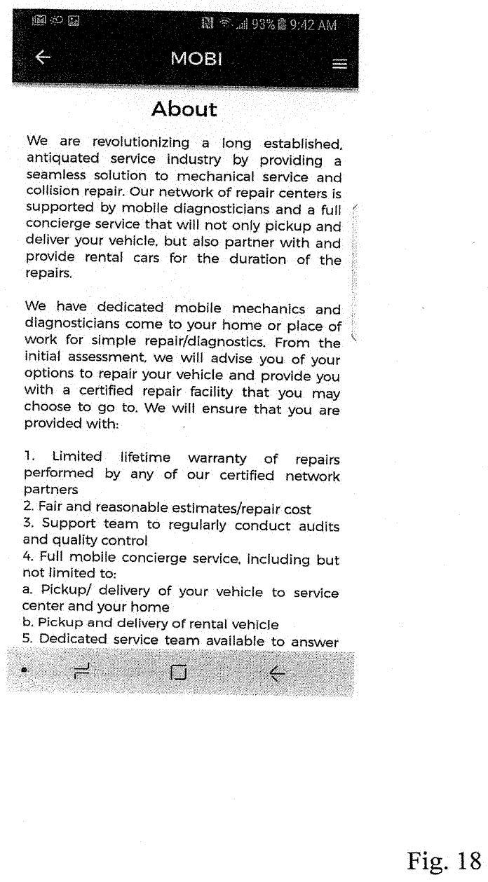

A screen shot showing an exemplary screen showing site location data on the concierge, called “MOBI”, of the present invention, is shown in FIG. 18. This screen may optionally present links to both web sites and/or locations of recommended service providers (not shown). The client-user simply clicks to be taken to the website of a service provider (not shown).

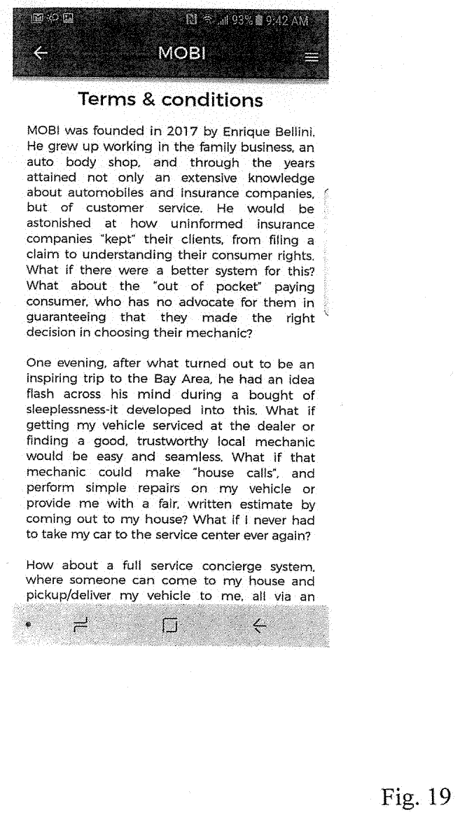

A screen shot showing an exemplary screen showing history data on the concierge, called “MOBI”, of the present invention, is shown in FIG. 19. Similarly, a screen shot showing an exemplary screen showing exemplary terms and conditions of the concierge, called “MOBI”, of the present invention, is shown in FIG. 20.

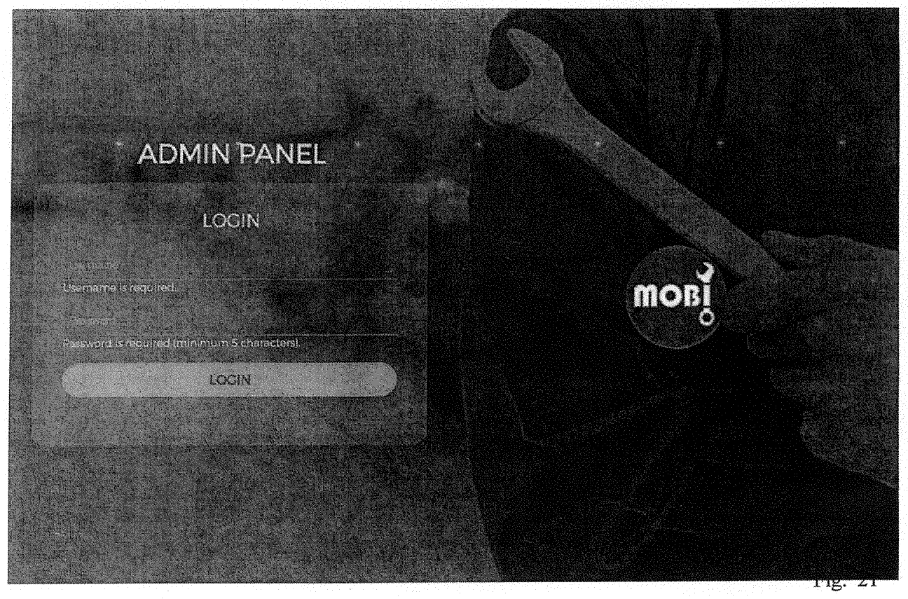

A screen shot showing an exemplary home, log in, screen of a computer monitor of the computerized diagnosis and referral system of the present invention as running at a central office of the concierge agency called “MOBI”, is shown in FIG. 21.

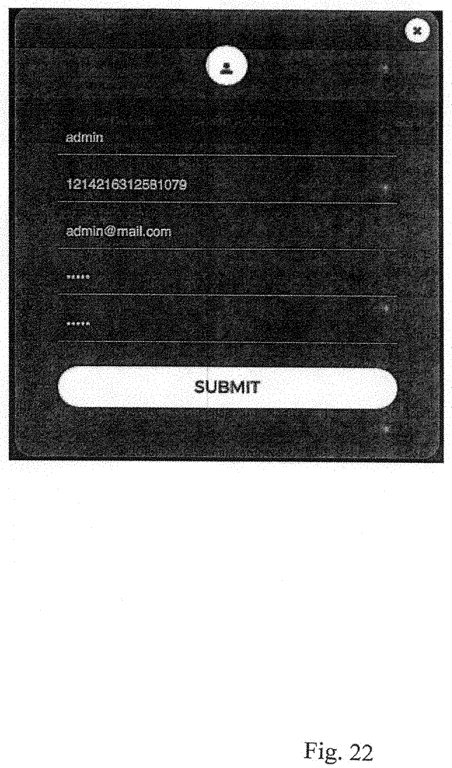

A screen shot showing a portion of the screen previously seen in FIG. 21 now entered with data sufficient to obtain administrative access to the computerized diagnosis and referral system of the present invention as running at a central office of the concierge agency called “MOBI”, is shown in FIG. 22.

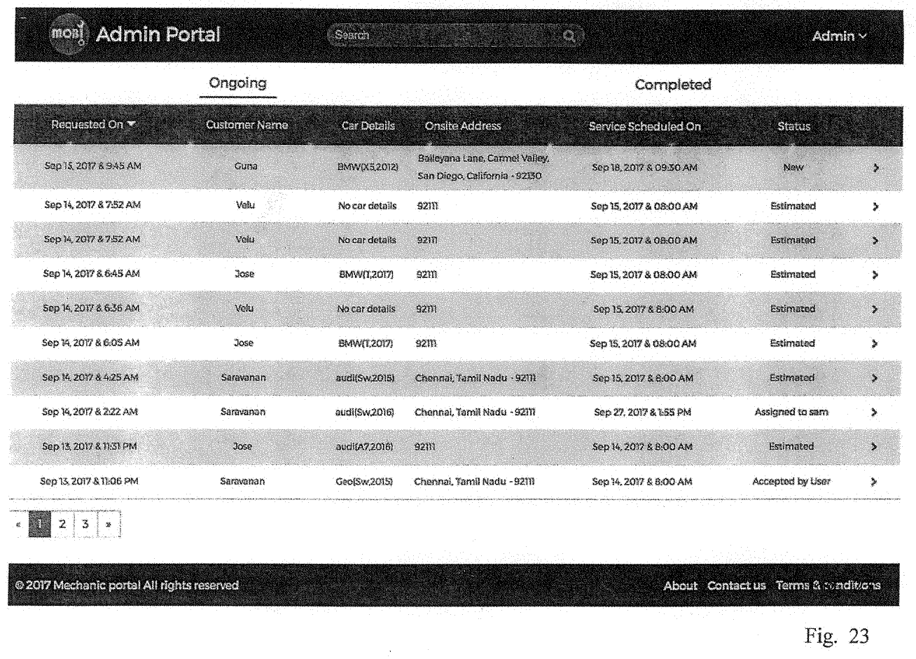

A screen shot showing a screen of exemplary pending present activity within the computerized diagnosis and referral system of the present invention as running at a central office of the concierge agency called “MOBI”, is shown in FIG. 23.

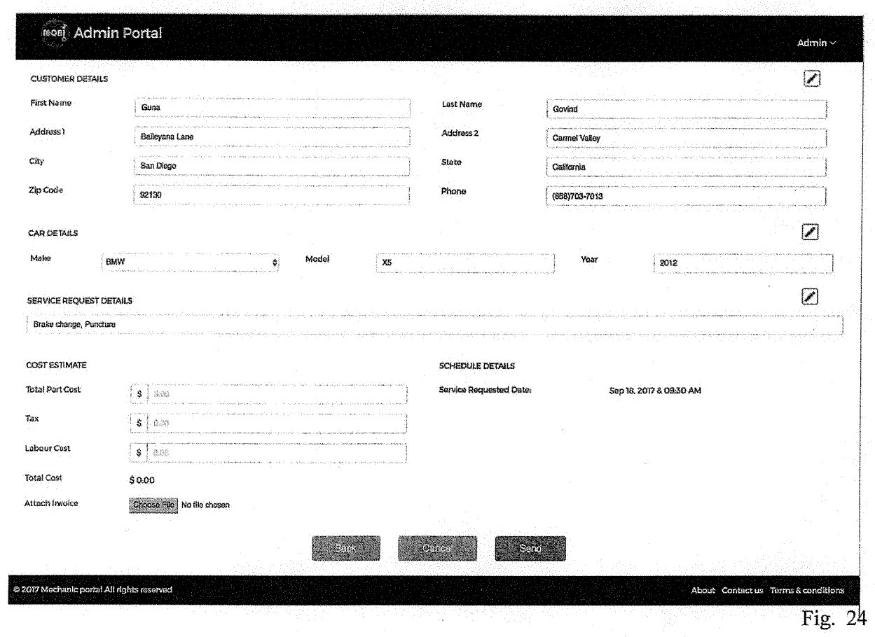

A screen shot showing an exemplary administrative screen of the computerized diagnosis and referral system of the present invention as running at a central office of the concierge agency called “MOBI”, the screen for managing client-user data for a particular incident, and partially filled in by an administrator with exemplary data, is shown in FIG. 24

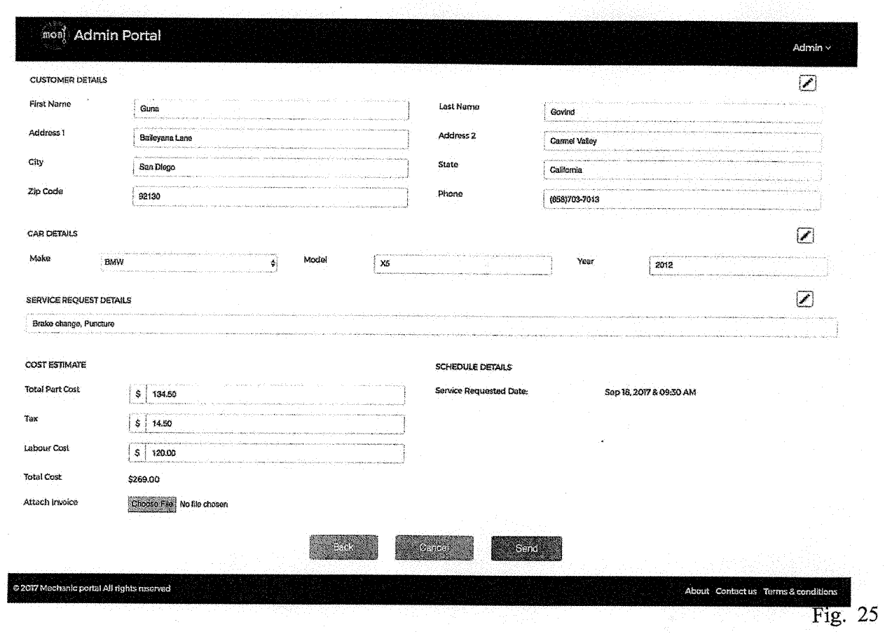

A screen shot showing the exemplary administrative screen of the computerized diagnosis and referral system previously seen in FIG. 24 is shown in FIG. 25. The screen is now completely filled in by an administrator with exemplary data.

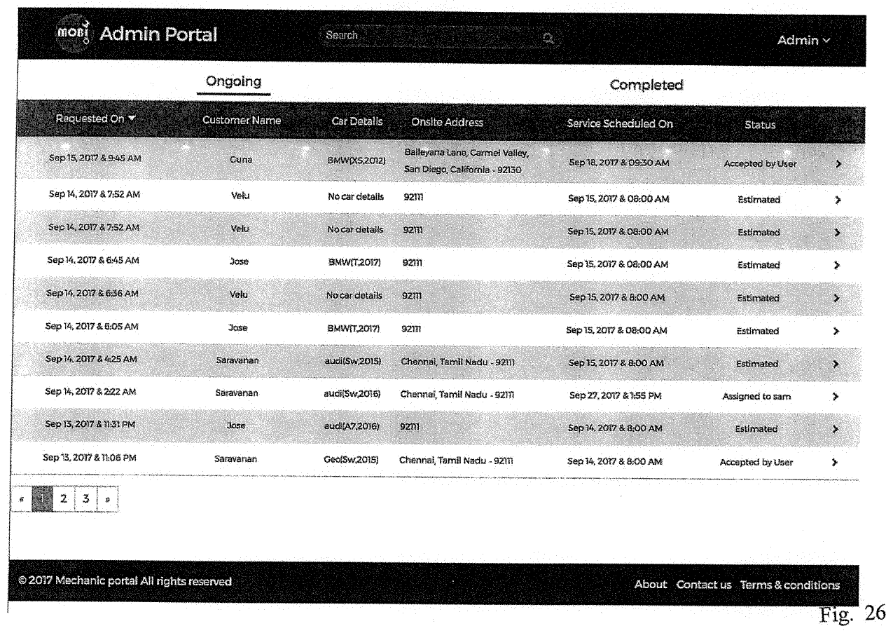

A screen shot of the exemplary administrative screen previously seen in FIG. 23 is shown in FIG. 26. The screen is now further filled in by an administrator.

A screen shot of the exemplary administrative screen previously seen in FIG. 25, the screen now further filled in by an administrator.

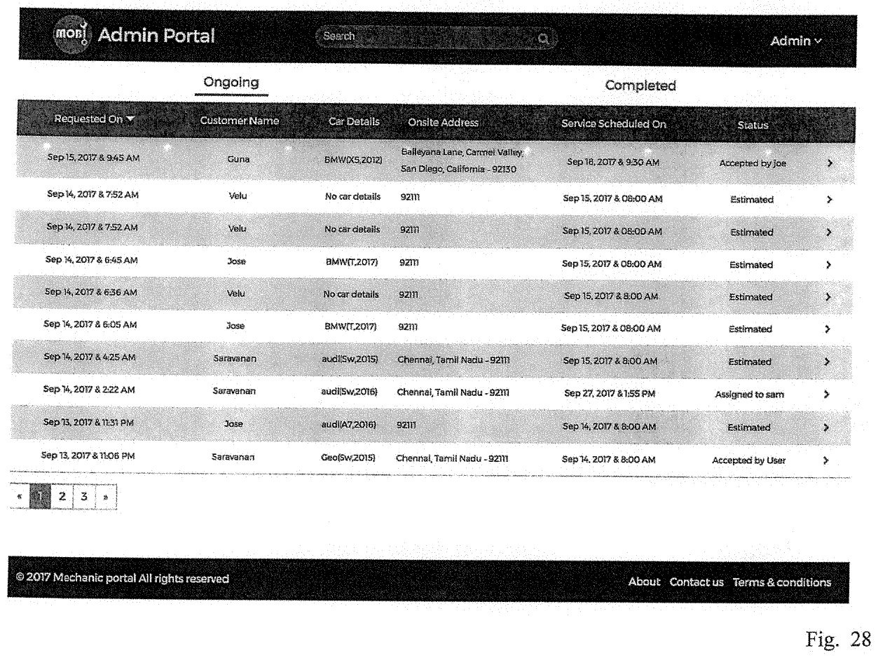

A screen shot of the exemplary administrative screen previously seen in FIG. 26 is shown in FIG. 28. The screen is now further filled in by an administrator.

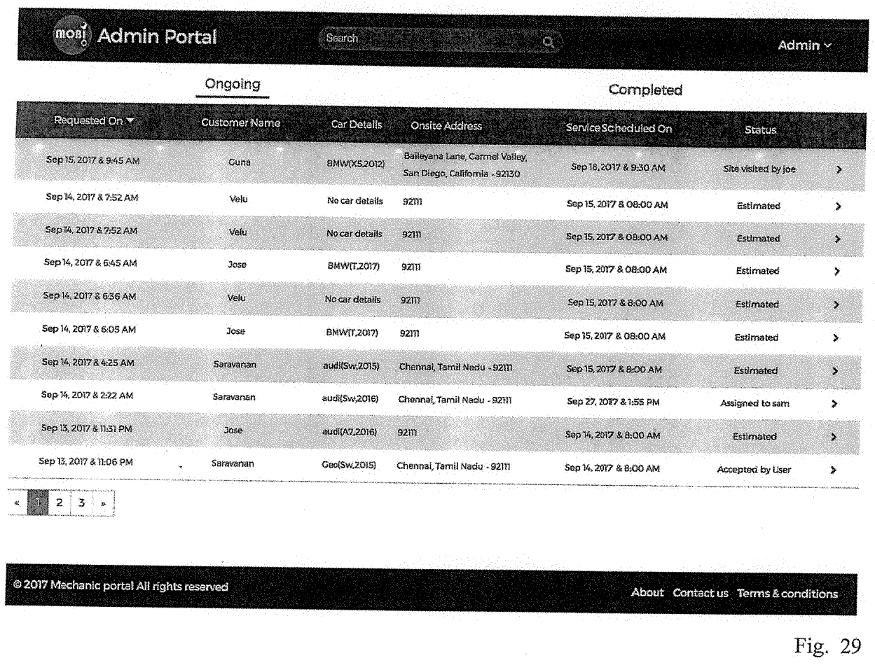

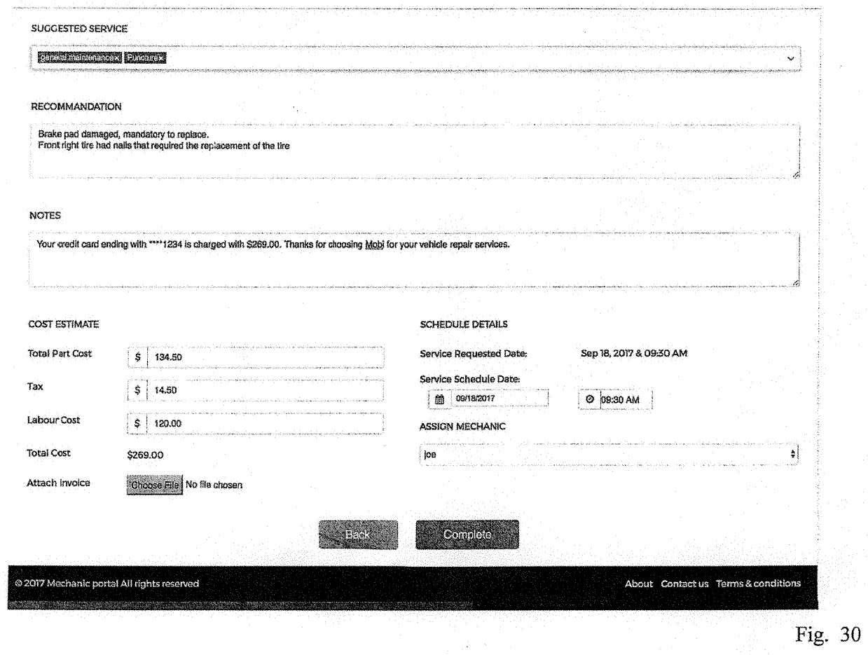

A screen shot of the exemplary administrative screen previously seen in FIG. 28 is shown in FIG. 29. The screen is now further filled in by an administrator.

Therefore the present invention has taught a system wherein, and a method whereby, a client-user need never visit an automotive service organization again. Total concierge service serves to permit the client-user to (1) diagnose all existing conditions of his/her car at any location and time and place of his or her choosing, (2) identify an entity or entities appropriate to perform all necessary maintenance and repairs, (3) receive if desired a written estimate of what required repair should cost, and, if desired, (4) have his/her car driven or transported to and from all service organizations selected by the client-user at times and at locations chosen, (5) have any and all questions about this process and about repairs both recommended and performed at any time, and (6) receive a supplemental, ironclad, warranty for all repairs made by recommended service providers. For this the client-user pays a fee. This fee plus referral fees paid by recommended and enrolled service providers—normally as a percentage of recommended and related repairs actually performed and paid—constitute the income of the concierge agency service,

The concept of he present invention is extendable beyond cars and other vehicles, and can be used for (1) planes, boats, all terrain vehicles and still other forms of transportation, (2) household repair services where substitute appliances and furnishing are repaired or replace as required, (3) gardening, horticulture, grounds keeping and arboreal services where problems need to be diagnosed, and replacement trees and shrubbery may potentially need to be delivered, and (4) still other applications the salient features of all of which are in common. Namely, (1) the situation needing rectification is normally beyond the expertise of an average consumer to know what to do, or even to accurately diagnose the problem; (2) because of this the consumer can, and often does, blunder into the wrong hands, and/or (3) repairs are often unneeded and/or misdirected and/or improperly made and/or overpriced, making that the customer hates the entire experience. Namely, the system and the method of the present invention rectify this problem by (1) first providing on site and at a convenient time and place to the client-user an independent and objective analysis of exactly what the client-user needs, where and from whom to get it, and how much it should cost, (2) second-supplying support services as desired in satisfying these needs while hand-holding the client-user through the entire experience, and (3) third-providing a warranty on the entire process. This system and method of the present invention is, as previously explained, directed to making the client-customer happy—for good cause. The correct repairs, and only the correct repairs, needed are diagnosed, painlessly performed, and warranted. A win-win situation for all parties involved is created.

These and other aspects are within the scope of present invention. Variants in the method, and the system, of the present invention are possible without defeating or avoiding the sense of the invention. For example, the concierge organization may refer itself for to perform necessary services with appropriate candor that it is so doing, and normally with the concurrent referral of a competitive service organization. For example, in the rare case where needed repairs are best, or only, performed by some service provider outside the system, than that (those) service providers will be recommended, and the client-user not “left hanging” nonetheless that the concierge organization will not expect to earn any fees for its referral. For example, it is totally expected that some client-users will perform diagnosed needed repairs themselves, or will later engage service providers not part of the system to perform these repairs. For example, formation of an intelligent cost estimate as to what recommended repairs should, and hopefully will, cost can sometimes, rarely, exceed the expertise and the information within the data bases of the concierge organization. In this case the concierge organization will make contact with an appropriate facility to find out, for example, the cost estimate for, by way of example, replacing the fender on a rare and exotic car, and will relay this information to the client-user. The examples cumulatively show that to go outside of the system, and the method, of the present invention in performance of certain of the steps thereof does not negate the present invention, nor render the modified system and process outside the scope of the present invention.

Therefore the scope of the present invention should be interpreted in accordance with the following claims, only, and not solely in accordance with that particular embodiment in which the invention has been taught.

What is claimed is:

1. A system for permitting an owner/operator of a vehicle needing repair to obtain repair of said vehicle, the system comprising:
a vehicular problem diagnosis and repair referral agency having
mobile agents that can and do travel to vehicles needing repairs and diagnose the problems of said vehicles,
databases for supporting the generation of accurate estimates as to what various vehicular repairs should and do cost,
communications capability for communicating with customer vehicle owner/operators as to (a) requests for diagnosis of, and referral of suitable repair services, for their vehicle needing repair, (b) where and when is located said vehicle, (c) negotiating a suitable time for diagnosis by a mobile agent, (d) information on repairs diagnosed by a mobile agent as being needed, and (e) one or more recommendations as to what repair shop or shops might suitably perform needed repairs and the cost estimate(s) therefore,
internal database creation and management capability to (a) enroll various vehicle repair shops, (b) supply to the customer lucid information of what repairs identified consist of and what it (they) should cost, and (c) recommend to the customer repair shops suitable to perform the repair(s); and
repair shops
enrolled with the agency to accept referrals of vehicles needing repair, and
contracted with the agency to pay a fee for all referred vehicles upon which repairs are actually performed;
wherein owner/operators of vehicles needing repair can contact the agency, arrange for and receive both a vehicle problem diagnosis and a cost estimate from a mobile agent, and proceed to have the repairs performed if they care to do so.

2. The system according to claim 1
wherein the agency charges the owner/operators for the vehicle diagnosis performed.

3. The system according to claim 2 wherein the agency permits a vehicle owner/operator paying for vehicle diagnosis to communicate with the agency regarding any of the conduct, cost and satisfaction/dissatisfaction realized from any repairs actually performed by a recommended repair shop.

4. The system according to claim 3 wherein the permitted communicating is by any of email, text message, or phone.

5. The system according to claim 2 wherein the permitted communicating is unlimited in extent.

6. The system according to claim 1
wherein the vehicular problem diagnosis agency can itself perform repairs;
wherein the communicating with customer vehicle owner/operators as to where and when and by whom said diagnosed repairs might be obtained includes the identity of the agency itself.

7. The system according to claim 1
wherein the agency, or the repair shops, or both the agency and the repair shops offer pick-up and delivery services to retrieve a vehicle needing a diagnosed repair, take it to be repaired by the agency or a repair shop approved by the owner/operator, and to return the vehicle when repaired;
whereby the owner/operator need not be involved with taking the vehicle to and from repair.

8. The system according to claim 1
wherein the agency's mobile agents also diagnose any outstanding maintenance requirements; and
wherein the agency's communication capability is also used to communicate any diagnosed outstanding maintenance requirements to the vehicle owner/operator.

9. The system according to claim
wherein the agency's communication capability further alerts all repair shops recommended to the owner/operator that they have been so recommended, to who they have been recommended, what services on what vehicle it has been recommended that they should perform, and what projected cost has been communicated to the owner/operator for these recommended services,

10. The system according to claim 1
wherein the agency's mobile agents also diagnose any outstanding safety issues with the vehicles; and
wherein the agency's communication capability is also used to communicate any safety issues with the vehicle to the vehicle owner/operator.

11. The system according to claim 1
wherein the mobile agents can and will perform, with authorization by the vehicle owner/operator, some repairs on the vehicle diagnosed.

12. The system according to claim 1
wherein the agency advises the vehicle owner/operator of his/her legal right to have repairs done by a repair shop of his/her choice regardless of insurance and/or warranty on the vehicle needing repair.

13. The system according to claim 1
wherein the agency warrants all repairs ultimately timely made by any repair shop or shops recommended to the vehicle owner/operator.

14. A method performed by a vehicle service agency providing service to an owner/operator of a vehicle needing repair, the method comprising:
enrolling at and to the agency a multiplicity of vehicular repair service organizations;
receiving at the agency from an owner/operator(s) of a vehicle needing repair an electronically communicated request to provide assistance to said owner/operator(s) directed towards realizing repairs to the vehicle;
dispatching from the agency its mobile agent in a mobile diagnostic vehicle to the vehicle needing repair; whereupon arrival at the vehicle
the mobile agent diagnoses any repair(s) needed by the vehicle; and then
the mobile agent electronically communicates his diagnosis to the agency; and
the agency or the agent or both the agency and the agent supply the vehicle owner/operator(s) with (a) results of the diagnosis plus (b) a recommendation, drawn from said multiplicity of vehicular repair service organizations, as to the identity of one or more of said multiplicity of vehicle repair service organizations where appropriate repair of the diagnosed problems of the diagnosed vehicle might suitably be obtained; whereupon
the agency alerts all enrolled vehicle repair service organizations identified to the owner/operator(s) of the diagnosed vehicle as to the identities of (a) the diagnosed vehicle and (b) the owner/operator(s) of the diagnosed vehicle, and © the repair(s) diagnosed as being needed;
receiving at the agency reporting from such vehicular repair service organization(s) as was (were) alerted if and when it each did actually ever perform repairs on said diagnosed vehicle, and the monetary amount thereof this (these) repair(s); and
further receiving at the agency a referral fee from all said enrolled vehicular repair service organizations as do actually perform repairs on vehicles of owner/operator(s) to which they were referred by the agency.

15. The method according to claim 14
wherein the request received at the agency is for repair a vehicle drawn from a class consisting essentially of cars and trucks.

16. The method according to claim 15 wherein the dispatching of a mobile agent is of an mobile agent that has expertise in diagnosing vehicles of the type identified to the agency from the owner/operator(s) of the vehicle.

17. The method according to claim 14
wherein the request received at the agency is for repair a vehicle drawn from the class consisting essentially of (1) vehicles needing mechanical repairs to facilitate their further use, and (2) vehicles needing bodywork as affects their appearance.

18. The method according to claim 17 wherein the dispatching of a mobile agent is of an mobile agent that has expertise directed to (1) mechanical repairs such as are needed by the vehicles needing mechanical repairs, or (2) vehicular bodywork such as is needed by the vehicles needing bodywork, as the case may be.

19. The method according to claim 14 wherein, after diagnosing any repair(s) needed by the vehicle, the mobile agent will, as a courtesy, perfunctorily fix the vehicle if it can be readily be so done by the mobile agent.

20. The method according to claim 14 wherein the agency or the mobile agent or both the agency and the mobile agent, as well as supplying the vehicle owner/operator(s) with (1) results of the diagnosis plus a recommendation to the identity of one or more vehicle repair service organizations where appropriate repair of the diagnosed problems of the might suitably be obtained, does (do) still further supply the vehicle owner/operator(s) with an estimate as to what the diagnosed problems should cost to repair.

21. The method according to claim 20 where the mobile agent carries a mechanics standard schedule of charges, and/or a bodywork shop standard schedule of changes, or both, to use, as appropriate, in making his/her estimate.

22. The method according to claim 14 wherein the agency contracts to answer up to a predetermined number of electronic communications from the owner/operator(s) of a diagnosed vehicle towards the end of answering further questions the owner/operator(s) may have towards the end of effectuating satisfactory repair of the vehicle.

23. The method according to claim 22 wherein the electronic communications are drawn from the group consisting essentially of (1) telephone calls, (2) text messages and (3) emails.

24. The method according to claim 23 wherein the owner/operator(s) is (are) permitted two telephone calls answered, and to have two emails responded to, by the agency per instance of vehicle diagnosed.

25. The method of claim 14 wherein the vehicle diagnostic and repair referral service is free to the owner/operator(s) of the diagnosed vehicle.

26. The method of claim 14 wherein the vehicle diagnostic and repair referral service is at a predetermined fixed fee to the owner/operator(s) of the diagnosed vehicle.

27. The method of claim 14 wherein the mobile agent diagnosing repair(s) needed by the vehicle that are mechanical in nature uses a portable engine diagnostic system in so doing.
